(19) United States
(12) Patent Application Publication
(10) Pub. No.: US 2025/0086847 A1
(43) Pub. Date: Mar. 13, 2025

(54) ENCODING METHOD, DECODING METHOD, AND READABLE STORAGE MEDIUM

(71) Applicant: GUANGDONG OPPO MOBILE TELECOMMUNICATIONS CORP., LTD., Dongguan (CN)

(72) Inventors: Hui YUAN, Dongguan (CN); Jinrui XING, Dongguan (CN); Tian GUO, Dongguan (CN); Dan ZOU, Dongguan (CN); Ming LI, Dongguan (CN)

(21) Appl. No.: 18/963,119

(22) Filed: Nov. 27, 2024

Related U.S. Application Data
(63) Continuation of application No. PCT/CN2022/096876, filed on Jun. 2, 2022.

(51) Int. Cl. G06T 9/40

(52) U.S. Cl. CPC G06T 9/40

(57) ABSTRACT

A coding method, an encoder, a decoder, and a readable storage medium are provided. The method includes the following. A reconstructed point set is determined based on a reconstructed point cloud, where the reconstructed point set includes at least one point. Geometry information and a reconstructed value of an attribute to-be-processed of a point in the reconstructed point set are input into a preset network model, and a processed value of the attribute to-be-processed of the point in the reconstructed point set is determined based on the preset network model. A processed point cloud corresponding to the reconstructed point cloud is determined according to the processed value of the attribute to-be-processed of the point in the reconstructed point set.

### CROSS-REFERENCE TO RELATED APPLICATION(S)

This application is a continuation of International Application No. PCT/CN2022/096876, filed Jun. 2, 2022, the entire disclosure of which is incorporated herein by reference.

### TECHNICAL FIELD

Embodiments of the disclosure relate to the field of point-cloud data processing technology, and more particularly, to an encoding method, a decoding method, and a readable storage medium.

### BACKGROUND

A three-dimensional (3D) point cloud is composed of a large number of points having geometry information and attribute information, and is a 3D data format. Since a point cloud usually has a large number of points and a large amount of data and occupies a large space, in order to facilitate storage, transmission, and subsequent processing, relevant organizations are currently studying point cloud compression, and a geometry-based point cloud compression (G-PCC) coding framework is a G-PCC platform proposed and being perfected by the relevant organization.

However, in the related art, in an existing G-PCC coding framework, only basic reconstruction is performed on an original point cloud. In the case of lossy attribute encoding, after reconstruction, a difference between a reconstructed point cloud and the original point cloud is likely to be large, which leads to severe distortion, thus affecting quality of the whole point cloud and visual effect.

### SUMMARY

In a first aspect, a decoding method is provided in embodiments of the disclosure. The method includes the following. A reconstructed point set is determined based on a reconstructed point cloud, where the reconstructed point set includes at least one point. Geometry information and a reconstructed value of an attribute to-be-processed of a point in the reconstructed point set are input into a preset network model, and a processed value of the attribute to-be-processed of the point in the reconstructed point set is determined based on the preset network model. A processed point cloud corresponding to the reconstructed point cloud is determined according to the processed value of the attribute to-be-processed of the point in the reconstructed point set.

In a second aspect, an encoding method is provided in embodiments of the disclosure. The method includes the following. Encoding and reconstruction are performed according to an original point cloud to obtain a reconstructed point cloud. A reconstructed point set is determined based on the reconstructed point cloud, where the reconstructed point set includes at least one point. Geometry information and a reconstructed value of an attribute to-be-processed of a point in the reconstructed point set are input into a preset network model, and a processed value of the attribute to-be-processed of the point in the reconstructed point set is determined based on the preset network model. A processed point cloud corresponding to the reconstructed point cloud is determined according to the processed value of the attribute to-be-processed of the point in the reconstructed point set.

### BRIEF DESCRIPTION OF THE DRAWINGS

FIG. 1 is a schematic diagram illustrating a framework of a geometry-based point cloud compression (G-PCC) encoder.

FIG. 2 is a schematic diagram illustrating a framework of a G-PCC decoder.

FIG. 3 is a schematic diagram illustrating zero run-length encoding.

FIG. 4 is a schematic flowchart of a decoding method provided in embodiments of the disclosure.

FIG. 5 is a schematic diagram illustrating a network structure of a preset network model provided in embodiments of the disclosure.

FIG. 6 is a schematic diagram illustrating a network structure of a graph attention mechanism module provided in embodiments of the disclosure.

FIG. 7 is a schematic flowchart of a detailed decoding method provided in embodiments of the disclosure.

FIG. 8 is a schematic diagram illustrating a network framework based on a preset network model provided in embodiments of the disclosure.

FIG. 9 is a schematic diagram illustrating a network structure of a graph attention based point layer (GAPLayer) module provided in embodiments of the disclosure.

FIG. 10 is a schematic diagram illustrating a network structure of a single-head GAPLayer module provided in embodiments of the disclosure.

FIG. 11 is a schematic diagram illustrating a test result of region adaptive hierarchical transform (RAHT) under test condition C1 provided in embodiments of the disclosure.

FIG. 12A and FIG. 12B are schematic diagrams illustrating comparison between point cloud pictures before and after quality enhancement provided in embodiments of the disclosure.

FIG. 13 is a schematic flowchart of an encoding method provided in embodiments of the disclosure.

FIG. 14 is a schematic structural diagram of an encoder provided in embodiments of the disclosure.

FIG. 15 is a schematic structural diagram illustrating hardware of an encoder provided in embodiments of the disclosure.

FIG. 16 is a schematic structural diagram of a decoder provided in embodiments of the disclosure.

FIG. 17 is a schematic structural diagram illustrating hardware of a decoder provided in embodiments of the disclosure.

FIG. 18 is a schematic structural diagram of a coding system provided in embodiments of the disclosure.

### DETAILED DESCRIPTION

To enable a more detailed understanding of features and technical content in embodiments of the disclosure, embodiments of the disclosure are described in detail below in conjunction with the accompanying drawings which are provided for illustrative purposes only and are not intended to limit embodiments of the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following elaboration, reference to “some embodiments” describes a subset of all possible embodiments, but it can be understood that “some embodiments” can refer to the same or different subsets of all possible embodiments and can be combined with each other without conflict. It is further noted that the terms “first/second/third” in embodiments of the disclosure are merely for distinguishing similar objects and do not imply a particular ordering with respect to the objects, and it can be understood that “first/second/third” can, where appropriate, be interchanged in a particular order or sequence so that embodiments of the disclosure described herein can be implemented in an order other than that illustrated or described herein.

Before further detailed elaboration of embodiments of the disclosure, the terms and terminology involved in embodiments of the disclosure are described, and the following explanation applies to the terms and terminology involved in embodiments of the disclosure.
Geometry-based point cloud compression (G-PCC or GPCC)
Video-based point cloud compression (V-PCC or VPCC)
Point cloud quality enhancement network (PCQEN)
Octree
Bounding box
K nearest neighbor (KNN)
Level of detail (LOD)
Predicting transform
Lifting transform
Region adaptive hierarchical transform (RAHT)
Multi-layer perceptron (MLP)
Farthest point sampling (FPS)
Peak signal to noise ratio (PSNR)
Mean square error (MSE)
Concatenate (Concat/Cat)
Common test condition (CTC)
Luminance/luma component (Luma or Y)
Blue chroma component (Chroma blue, Cb)
Red chroma component (Chroma red, Cr)

A point cloud is a three-dimensional (3D) representation of the surface of an object. The point cloud (data) of the surface of the object can be captured by means of a capturing equipment such as a photo radar, a LIDAR, a laser scanner, and a multi-view camera.

The point cloud is a collection of massive amounts of 3D points. A point in the point cloud can have both position information and attribute information of the point. For example, the position information of the point can be 3D coordinate information of the point. The position information of the point can also be referred to as geometry information of the point. For example, the attribute information of the point can include colour information and/or reflectance, etc. For example, the colour information can be information in any colour space. For example, the colour information can be read-green-blue (RGB) information, where R represents red, G represents green, and B represents blue. Another example of the colour information can be luminance-chrominance (YCbCr, YUV) information, where Y represents luminance (Luma), Cb (U) represents blue chrominance, and Cr (V) represents red chrominance.

For a point cloud obtained based on laser measurement, a point in the point cloud can include 3D coordinate information of the point and laser reflectance of the point. For another example, for a point cloud obtained based on photogrammetry, a point in the point cloud can include 3D coordinate information of the point and colour information of the point. For another example, for a point cloud obtained based on laser measurement and photogrammetry, a point in the point cloud can include the 3D coordinate information of the point, the laser reflectance of the point, and the colour information of the point.

With regard to the approach for acquiring the point cloud, the point cloud can be classified into:
a first category of static point cloud: the object is stationary, and the device for acquiring the point cloud is also stationary;
a second category of dynamic point cloud: the object is moving, but the device for acquiring the point cloud is stationary; and
a third category of dynamically-acquired point cloud: the device for acquiring the point cloud is moving.

For example, with regard to usage of the point cloud, the point cloud can be classified into two main categories:
category 1: machine-perceived point cloud, which can be used in scenarios such as autonomous navigation systems, real-time inspection systems, geographic information systems, visual sorting robots, and rescue and disaster relief robots; and
category 2: human-eye-perceived point cloud, which can be used in scenarios such as digital cultural heritage, free point-of-view broadcasting, 3D immersive communication, and 3D immersive interaction.

As the point cloud is a collection of massive amounts of points, storage of the point cloud not only consumes a lot of memory, but also is not conducive to transmission. In addition, there is no such large bandwidth available to support the transmission of the point cloud directly across the network layer without compression. Therefore, the point cloud needs to be compressed.

As of today, point cloud coding frameworks that can compress the point cloud are either a G-PCC coding framework or a V-PCC coding framework provided by moving picture experts group (MPEG), or an audio video standard (AVS)-PCC coding framework provided by AVS. The G-PCC coding framework can be used for compression of the first category of static point cloud and the third category of dynamically-acquired point cloud, and the V-PCC coding framework can be used for compression of the second category of dynamic point cloud. In embodiments of the disclosure, the elaborations herein is mainly intended for the G-PCCcoding framework.

In embodiments of the disclosure, a 3D point cloud is composed of a large number of points having information such as coordinates and colour, and is a 3D data format. Since a point cloud usually has a large number of points and a large amount of data and occupies a large space, in order to to facilitate storage, transmission, and subsequent processing, relevant organizations (for example, international organization for standardization (ISO), international electrotechnical commission (IEC), joint technical committee for information technology (JTC1), or work group 7 (WG7), etc.) are currently studying point cloud compression. The G-PCC coding framework is a G-PCC platform proposed and being perfected by these organizations.

Specifically, in the G-PCC coding framework, a point cloud input into a 3D picture model is partitioned into slices, and then each of the slices is encoded independently.

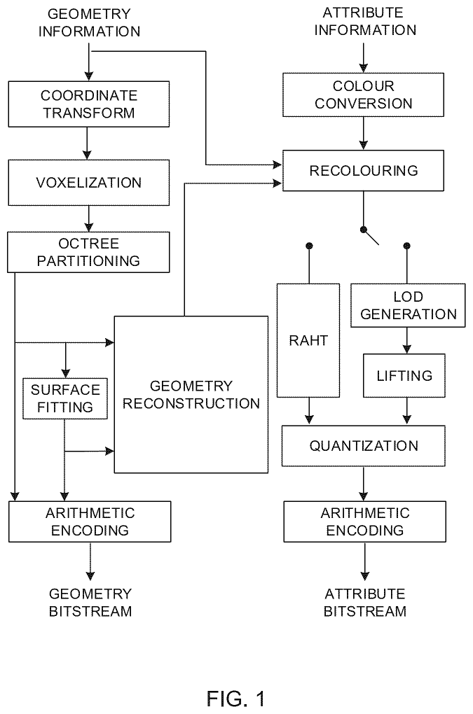

FIG. 1 is a schematic diagram illustrating a framework of a G-PCC encoder. As illustrated in FIG. 1, the G-PCC encoder is applied to a point cloud encoder. In a G-PCC encoding framework, point cloud data to-be-encoded is firstly partitioned into slices. In each slice, the geometry information of the point cloud and attribute information corresponding to each point cloud are encoded separately. In geometry encoding, coordinate transform is performed on the geometry information such that the whole point cloud is contained in a bounding box. This is followed by quantization, which is mainly a scaling process. Due to rounding in the quantization, some of the points have the same geometry information. Duplicated points are removed depending on parameters. The process of quantization and removing duplicated points is also known as voxelization. Next, octree partitioning is performed on the bounding box. In an octree-based geometry information encoding process, the bounding box is octeted into 8 sub-cubes. Non-null sub-cubes (containing points in the point cloud) continue to be octeted until a resulting leaf node is a 1×1×1 unit cube. Arithmetic encoding is performed on points in the leaf node to generate a binary geometry bitstream, i.e., a geometry bitstream. In a triangle soup (trisoup)-based geometry information encoding process, the octree partitioning is also performed first. However, different from the octree-based geometry encoding, instead of partitioning the point cloud layer-by-layer into 1×1×1 unit cubes, the partitioning is stopped when the side length of the block is W. Based on a surface formed by distribution of the point cloud in each block, up to 12 vertexes generated between the 12 edges of the block and the surface are obtained. Arithmetic encoding is performed on the vertexes (with surface fitting performed based on the vertexes) to generate the binary geometry bitstream, i.e. the geometry bitstream. The vertexes are also used in the implementation of the geometry reconstruction, and reconstructed geometry information is used in attribute encoding of the point cloud.

In an attribute encoding process, after finishing geometry encoding and reconstructing the geometry information, colour conversion is performed to convert the colour information (i.e., attribute information) from the RGB colour space to the YUV colour space. The reconstructed geometry information is then used to recolour the point cloud, so as to make the uncoded attribute information correspond to the reconstructed geometry information. The attribute encoding is mainly intended for colour information. There are two main transform methods for encoding of the colour information: 1. distance-based lifting transform that relies on LOD partitioning; 2. direct RAHT, both of which convert the colour information from the spatial domain to the frequency domain to obtain high frequency coefficients and low frequency coefficients. The coefficients are quantized (i.e., coefficient quantization). Finally, slice synthesis is performed on encoded geometry data obtained after octree partitioning and surface fitting and encoded attribute data obtained after coefficient quantization, and then the vertex coordinates of each block are encoded in sequence (i.e., arithmetic encoding) to generate a binary attribute bitstream, i.e., an attribute bitstream.

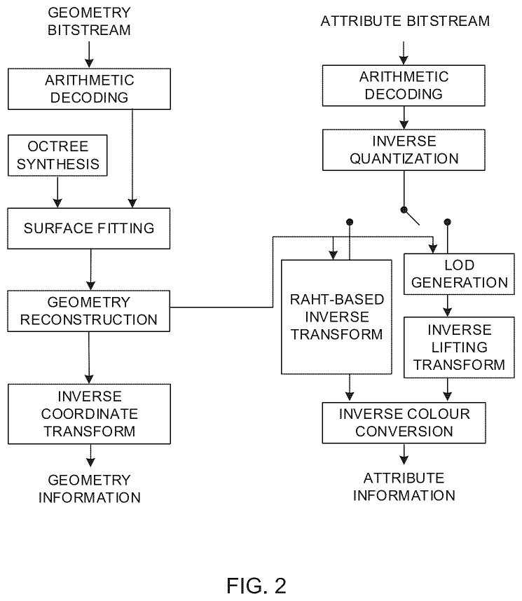

FIG. 2 is a schematic diagram illustrating a framework of a G-PCC decoder. As illustrated in FIG. 2, the G-PCC decoder is applied to a point cloud coder. In a G-PCC decoding framework, for an obtained binary bitstream, a geometry bitstream and an attribute bitstream in the binary bitstream are first decoded separately. In decoding of the geometry bitstream, geometry information of a point cloud is obtained through arithmetic decoding, octree synthesis, surface fitting, geometry reconstruction, and inverse coordinate transform. In decoding of the attribute bitstream, attribute information of the point cloud is obtained through arithmetic decoding, inverse quantization, LOD-based inverse lifting transform or RAHT-based inverse transform, and inverse colour conversion. A 3D picture model of point cloud data to-be-encoded is restored based on the geometry information and the attribute information.

In the foregoing G-PCC encoder illustrated in FIG. 1, LOD partitioning is mainly used for two manners of point cloud attribute transform: predicting transform and lifting transform.

It should also be noted that, LOD partitioning is performed after geometric reconstruction of the point cloud, and geometry coordinate information of the point cloud can be obtained directly. The point cloud is partitioned into multiple LODs according to an euclidean distance between points in the point cloud. Colours of points in the LODs are decoded in sequence. The number of zeros (represented by zero_cnt) in a zero run-length encoding technology is calculated, and a residual is decoded according to the value of zero_cnt.

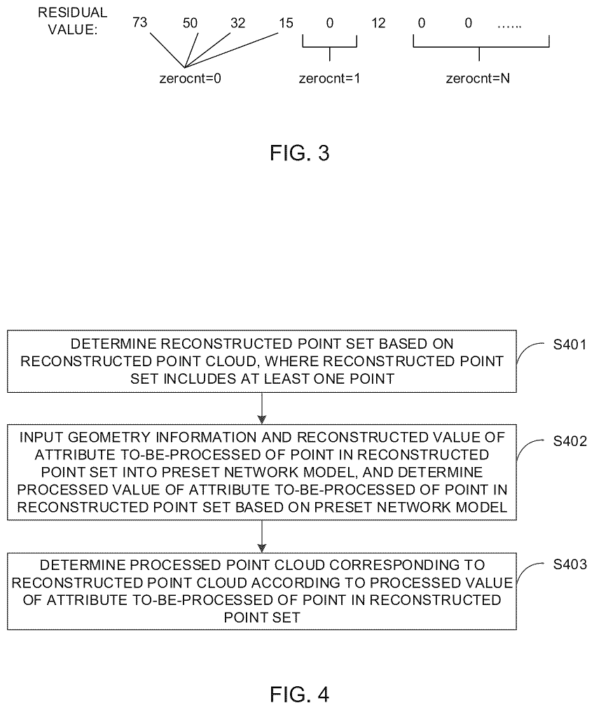

Decoding is performed according to a zero run-length encoding method. First, the value of a 1^{st} zero_cnt in the bitstream is decoded. If the 1^{st} zero_cnt is greater than 0, it means that there are zero_cnt consecutive residuals that are 0. If zero_cnt is equal to 0, it means that an attribute residual of the point is not 0. Then a corresponding residual value is decoded, and the decoded residual value is inversely-quantized and added to a colour predicted value of the current point to obtain a reconstructed value of the point. This operation is continued until all points in the point cloud are decoded. For example, FIG. 3 is a schematic structural diagram illustrating zero run-length encoding. As illustrated in FIG. 3, if the residual value is 73, 50, 32, or 15, zero_cnt is equal to 0. If there is only one residual value and the residual value is 0, zero_cnt is equal to 1. If there are N residual values and the residual values are 0, zero_cnt is equal to N.

That is, a colour reconstructed value of the current point (represented by reconstructedColour) is calculated based on a colour predicted value (represented by predictedColour) under a current prediction mode and an inversely-quantized colour residual value (represented by residual) under the current prediction mode, that is, reconstructedColour=predictedColour+residual. In addition, the current point will be used as the nearest neighbor of a point in subsequent LOD, and the colour reconstructed value of the current point will be used for attribute prediction of the subsequent points.

In the related art, most of the technologies for attribute quality enhancement of a reconstructed point cloud in the G-PCC coding framework rely on some classical algorithms, while only few of them rely on a deep learning method to implement quality enhancement. Two algorithms for implementing post-processing for quality enhancement on the reconstructed point cloud will be described below.

(1) Kalman filtering algorithm: a Kalman filter is an efficient recursive filter. With the Kalman filter, it is possible to gradually reduce a prediction error of a system, and the Kalman filter is particularly suitable for stable random signals. The Kalman filter utilizes an estimate of a prior state to find an optimal value for the current state. The Kalman filter includes three major modules, namely a prediction module, a refinement module, and an update module. An attribute reconstructed value of a previous point is used as a measurement value, Kalman filtering (a basic method) is performed on an attribute predicted value of a current point, and an accumulated error in predicting transform is refined. Then, some optimizations can be made for the algorithm: in encoding, true values of some points are reserved at an equal interval and used as measurement values for Kalman filtering, which can improve filtering performance and accuracy of attribute prediction. The Kalman filter will be disabled if the standard deviation of a signal is large, and filtering can be performed only on U and V components, etc.

(2) Wiener filtering algorithm: with regard to a Wiener filter, minimizing the mean square error is taken as a criterion, i.e. minimize an error between a reconstructed point cloud and an original point cloud. At an encoding end, for each reconstructed point, a group of optimal coefficients are calculated according to a neighborhood of the reconstructed point, and then the reconstructed point is filtered. Based on whether quality of the filtered point cloud is improved, the coefficients are selectively signalled into a bitstream and transmitted to a decoding end. At the decoding end, the optimal coefficient can be decoded to perform post-processing on the reconstructed point cloud. Then, some optimizations can be made for the algorithm: selection regarding the number of neighbor points is optimized; and if a point cloud is large, the point cloud is firstly patched and then filtered, so as to reduce memory consumption, etc.

That is, in the G-PCC coding framework, only basic reconstruction is performed on a point-cloud sequence. With regard to a lossy (or near-lossless) attribute encoding method, after reconstruction, no corresponding post-processing operation is performed to further improve attribute quality of a reconstructed point cloud. As a result, a difference between the reconstructed point cloud and an original point cloud is likely to be large, which leads to severe distortion, thus affecting quality of the whole point cloud and visual effect.

However, some classical algorithms proposed in the related art are relatively simple in principle and simple in method, but sometimes it is difficult to achieve a better effect, that is, the quality finally obtained still has a large room for improvement. Compared with the traditional algorithm, deep learning has some advantages, for example, has stronger learning capability, and is able to extract underlying and fine features; is characterized in wide coverage, high adaptability, and robustness, and is able to solve complicated problems; is driven by data and has higher upper limit; and has excellent transportability. Therefore, a neural network-based point-cloud quality enhancement technology is proposed.

Provided is a coding method. A reconstructed point set is determined based on a reconstructed point cloud, where the reconstructed point set includes at least one point. Geometry information and a reconstructed value of an attribute to-be-processed of a point in the reconstructed point set are input into a preset network model, and a processed value of the attribute to-be-processed of the point in the reconstructed point set is determined based on the preset network model. A processed point cloud corresponding to the reconstructed point cloud is determined according to the processed value of the attribute to-be-processed of the point in the reconstructed point set. In this way, by performing quality enhancement on attribute information of the reconstructed point cloud based on the preset network model, not only end-to-end operation is achieved, but also patching of the reconstructed point cloud is realized by determining the reconstructed point set from the reconstructed point cloud, thereby effectively reducing resource consumption and improving robustness of the model. In addition, when performing quality enhancement on the attribute information of the reconstructed point cloud based on the preset network model by using the geometry information as an auxiliary input of the preset network model, it is possible to make the processed point have clearer texture and more natural transition, which can effectively improve quality of the point cloud and visual effect, thereby improving compression performance of the point cloud.

Embodiments of the disclosure provide a coding method, an encoder, a decoder, and a readable storage medium, which can improve the quality of a point cloud, improve a visual effect, and improve compression performance of the point cloud.

Various embodiments of the disclosure will be described clearly and completely below with reference to the accompanying drawings.

In an embodiment of the disclosure, referring to FIG. 4, FIG. 4 is a schematic flowchart of a decoding method provided in embodiments of the disclosure. As illustrated in FIG. 4, the method can include the following.

S401, a reconstructed point set is determined based on a reconstructed point cloud, where the reconstructed point set includes at least one point.

S402, geometry information and a reconstructed value of an attribute to-be-processed of a point in the reconstructed point set are input into a preset network model, and a processed value of the attribute to-be-processed of the point in the reconstructed point set is determined based on the preset network model.

S403, a processed point cloud corresponding to the reconstructed point cloud is determined according to the processed value of the attribute to-be-processed of the point in the reconstructed point set.

It should be noted that, the decoding method described in embodiments of the disclosure specifically refers to a point-cloud decoding method and can be applied to a point-cloud decoder (which can be referred to as “decoder” for short in embodiments of the disclosure).

It should also be noted that, in embodiments of the disclosure, the decoding method is mainly applied to a technology for post-processing of attribute information of a reconstructed point cloud obtained through G-PCC decoding, and specifically, a graph-based PCQEN is proposed. In the preset network model, a graph structure is constructed for each point by using geometry information and a reconstructed value of an attribute to-be-processed, and then feature extraction is performed through graph convolution and graph attention mechanism. By learning a residual between the reconstructed point cloud and an original point cloud, it is possible to make the reconstructed point cloud be similar to the original point cloud as much as possible, thereby realizing quality enhancement.

It can be understood that, in embodiments of the disclosure, each point in the reconstructed point cloud has geometry information and attribute information. The geometry information represents a spatial position of the point, which can also be referred to as 3D geometry coordinate information and represented by (x, y, z). The attribute information represents an attribute value of the point, such as a colour-component value.

Here, the attribute information can include a colour component, which is specifically colour information of any colour space. Exemplarily, the attribute information can be colour information of an RGB space, or can be colour information of a YUV space, or can be colour information of a YCbCr space, and the like, and embodiments of the disclosure are not limited in this regard.

In embodiments of the disclosure, the colour component can include at least one of a first colour component, a second colour component, or a third colour component. In this case, taking a colour component as an example of the attribute information, if the colour component complies with the RGB colour space, it can be determined that the first colour component, the second colour component, and the third colour component are an R component, a G component, and a B component respectively; if the colour component complies with the YUV colour space, it can be determined that the first colour component, the second colour component, and the third colour component are a Y component, a U component, and a V component respectively; if the colour component complies with the YCbCr colour space, it can be determined that the first colour component, the second colour component, and the third colour component are a Y component, a Cb component, and a Cr component respectively.

It can also be understood that, in embodiments of the disclosure, for each point, in addition to the colour component, the attribute information of the point can also include reflectance, a refractive index, or other attributes, which is not specifically limited herein.

Further, in embodiments of the disclosure, the attribute to-be-processed refers to attribute information on which quality enhancement is currently to be performed. Taking the colour component as an example, the attribute to-be-processed can be one-dimension information, for example, the first colour component, the second colour component, or the third colour component; alternatively, the attribute to-be-processed can be two-dimension information, for example, a combination of any two of the first colour component, the second colour component, and the third colour component; alternatively, the attribute to-be-processed can even be three-dimension information including the first colour component, the second colour component, and the third colour component, which is not specifically limited herein.

That is, for each point in the reconstructed point cloud, the attribute information can include three colour components. However, when performing quality enhancement on the attribute to-be-processed by using the preset network model, only one colour component may be processed each time, that is, a single colour component and geometry information are used as inputs of the preset network model, so as to implement quality enhancement on the single colour component (the other colour components remain unchanged). Then, the same applies to the other two colour components to input the other two colour components into corresponding preset network models for quality enhancement. Alternatively, when performing quality enhancement on the attribute to-be-processed by using the preset network model, instead of processing only one colour component each time, all of the three colour components and the geometry information may be used as inputs of the preset network model. In this way, time complexity can be reduced, but quality enhancement effect will be slightly degraded.

Further, in embodiments of the disclosure, the reconstructed point cloud can be obtained by performing attribute encoding, attribute reconstruction, and geometry compensation on the original point cloud. For a point in the original point cloud, a predicted value and a residual value of attribute information of the point can be firstly determined, and then a reconstructed value of the attribute information of the point is calculated by using the predicted value and the residual value, so as to construct the reconstructed point cloud. In some embodiments, the method can further include the following. A bitstream is parsed to determine a residual value of an attribute to-be-processed of the point in the original point cloud; attribute prediction is performed on the attribute to-be-processed of the point in the original point cloud to determine a predicted value of the attribute to-be-processed of the point in the original point cloud; a reconstructed value of the attribute to-be-processed of the point in the original point cloud is determined according to the residual value of the attribute to-be-processed of the point in the original point cloud and the predicted value of the attribute to-be-processed of the point in the original point cloud, thereby determining the reconstructed point cloud.

Specifically, for a point in the original point cloud, when determining a predicted value of an attribute to-be-processed of the point, prediction can be performed on attribute information of the point according to geometry information and attribute information of multiple target neighbor points of the point in conjunction with geometry information of the point, so as to obtain a corresponding predicted value. Then addition calculation is performed according to a residual value of the attribute to-be-processed of the point and the predicted value of the attribute to-be-processed of the point, so as to obtain a reconstructed value of the attribute to-be-processed of the point. In this way, for the point in the original point cloud, after the reconstructed value of the attribute information of the point is determined, the point can be used as a nearest neighbor of a point in subsequent LOD to perform attribute prediction on the subsequent point by using the reconstructed value of the attribute information of the point, and as such, the reconstructed point cloud can be obtained.

That is, in embodiments of the disclosure, the original point cloud can be obtained directly by using a point-cloud reading function in a coding program, and the reconstructed point cloud is obtained after all encoding operations are completed. In addition, the reconstructed point cloud in embodiments of the disclosure can be a reconstructed point cloud that is output after decoding, or can be used as a reference for decoding a subsequent point cloud. Furthermore, the reconstructed point cloud herein can be in a prediction loop, that is, used as an inloop filter and used as a reference for decoding a subsequent point cloud; or can be outside the prediction loop, that is, used as a post filter and not used as a reference for decoding a subsequent point cloud, which is not specifically limited herein.

It can also be understood that, in embodiments of the disclosure, considering the number of points in the reconstructed point cloud, for example, the number of points in some large point clouds can exceed 10 million, before the reconstructed point cloud is input into the preset network model, patch extraction can be performed on the reconstructed point cloud. Here, each reconstructed point set can be regarded as one patch, and each patch extracted includes at least one point.

In some embodiments, in S401, the reconstructed point set can be determined based on the reconstructed point cloud as follows. A key point is determined from the reconstructed point cloud. Extraction is performed on the reconstructed point cloud according to the key point to determine the reconstructed point set, where the key point and the reconstructed point set have a correspondence.

In an embodiment, the key point can determined from the reconstructed point cloud as follows. The key point is determined by performing farthest point sampling (FPS) on the reconstructed point cloud.

In embodiments of the disclosure, P key points can be obtained by means of FPS, where P is an integer and P>0. Here, for the P key points, each key point corresponds to one patch, that is, each key point corresponds to one reconstructed point set.

Specifically, for each key point, patch extraction can be performed to obtain a reconstructed point set corresponding to the key point. Taking a certain key point as an example, in some embodiments, extraction can be performed on the reconstructed point cloud according to the key point to determine the reconstructed point set as follows. KNN search is performed in the reconstructed point cloud according to key point, to determine a neighbor point corresponding to the key point. The reconstructed point set is determined based on the neighbor point corresponding to the key point.

Further, with regard to KNN search, in an embodiment, KNN search can be performed in the reconstructed point cloud according to the key point to determine the neighbor point corresponding to the key point as follows. Based on the key point, search for a first preset number of candidate points in the reconstructed point cloud through KNN search. A distance between the key point and each of the first preset number of candidate points is calculated, and a second preset number of smaller distances are determined from the obtained first preset number of distances. The neighbor point corresponding to the key point is determined according to candidate points corresponding to the second preset number of distances.

In embodiments of the disclosure, the second preset number is smaller than or equal to the first preset number.

It should also be noted that, taking a certain key point as an example, the first preset number of candidate points can be found from the reconstructed point cloud through KNN search, the distance between the key point and each of the candidate points is calculated, and then the second preset number of candidate points that are closest to the key point are selected from the candidate points. The second preset number of candidate points are used as neighbor points corresponding to the key point, and the reconstructed point set corresponding to the key point is formed according to the neighbor points.

In addition, in embodiments of the disclosure, the reconstructed point set may include the key point itself, or may not include the key point itself. If the reconstructed point set includes the key point itself, in some embodiments, the reconstructed point set can be determined based on the neighbor point corresponding to the key point as follows. The reconstructed point set is determined based on the key point and the neighbor point corresponding to the key point.

It should also be noted that, the reconstructed point set can include n points, where n is an integer and n>0. Exemplarily, n can be 2048, but no limitation is imposed thereto.

In a possible implementation, if the reconstructed point set includes the key point itself, the second preset number can be equal to (n−1). That is, after the first preset number of candidate points are found from the reconstructed point cloud through KNN search, the distance between the key point and each of the candidate points is calculated, then (n−1) neighbor points that are closest to the key point are selected from these candidate points, and the reconstructed point set can be formed according to the key point itself and the (n−1) neighbor points. Here, the (n−1) neighbor points specifically refer to (n−1) neighbor points in the reconstructed point cloud that are closest to the key point in terms of geometry distance.

In another possible implementation, if the reconstructed point set does not include the key point itself, the second preset number can be equal to n. That is, after the first preset number of candidate points are found from the reconstructed point cloud through KNN search, the distance between the key point and each of the candidate points is calculated, then n neighbor points that are closest to the key point are selected from the candidate points, and the reconstructed point set can be formed according to the n neighbor points. Here, the n neighbor points specifically refer to n neighbor points in the reconstructed point cloud that are closest to the key point in terms of geometry distance.

It should also be noted that, for the determination of the number of key points, there is an association between the number of key points, the number of points in the reconstructed point cloud, and the number of points in the reconstructed point set. Therefore, in some embodiments, the method can further include the following. The number of points in the reconstructed point cloud is determined. The number of key points is determined according to the number of points in the reconstructed point cloud and the number of points in the reconstructed point set.

In an embodiment, the number of key points can be determined according to the number of points in the reconstructed point cloud and the number of points in the reconstructed point set as follows. A first factor is determined. A product of the number of points in the reconstructed point cloud and the first factor is calculated. The number of key points is determined according to the product and the number of points in the reconstructed point set.

In embodiments of the disclosure, the first factor can be represented by Y, which is referred to as a duplication-rate factor and is used to control the average number of times that each point is fed into the preset network model. Exemplarily, Y=3, but no limitation is imposed thereto.

In an embodiment, assuming that the number of points in the reconstructed point cloud is N, the number of points in the reconstructed point set is n, and the number of key points is P, then the relationship between the three is as follows:

$$P = round ( \frac{N \times γ}{n} ) \qquad ( 1 )$$

That is, for the reconstructed point cloud, P key points can be determined by means of FPS, and then patch extraction is performed with regard to each key point, specifically, KNN search where K=n is performed for each key point, so that P patches with the size of n can be obtained, i.e. P reconstructed point sets are obtained, and each reconstructed point set includes n points.

In addition, it should also be noted that, for the points in the reconstructed point cloud, there may be duplication of points in the P reconstructed point sets. In other words, a certain point may appear in multiple reconstructed point sets, or may not appear in any of the P reconstructed point sets. This is the role of the first factor (γ), that is, to control an average duplication rate at which each point appears in the P reconstructed point sets, so as to better improve quality of the point cloud when performing patch fusion.

Further, in embodiments of the disclosure, the point cloud is usually represented by an RGB colour space, but a YUV colour space is usually adopted when performing quality enhancement on the attribute to-be-processed through the preset network model. Therefore, before inputting the geometry information and the reconstructed value of the attribute to-be-processed of the point in the reconstructed point set into the preset network model, colour space conversion needs to be performed on a colour component(s). Specifically, in some embodiments, if the colour component does not comply with the YUV colour space, colour space conversion is performed on the colour component of the point in the reconstructed point set, to make the converted colour component comply with the YUV colour space. For example, the colour components are converted into the YUV colour space from the RGB colour space, and then a colour component (for example, a Y component) which requires quality enhancement is extracted and then input into the preset network model together with geometry information.

In some embodiments, in S402, the geometry information and the reconstructed value of the attribute to-be-processed of the point in the reconstructed point set can be input into the preset network model and the processed value of the attribute to-be-processed of the point in the reconstructed point set can be determined based on the preset network model as follows. In the preset network model, a graph structure of the point in the reconstructed point set is obtained by performing graph construction based on the reconstructed value of the attribute to-be-processed of the point in the reconstructed point set additionally with the geometry information of the point in the reconstructed point set, and the processed value of the attribute to-be-processed of the point in the reconstructed point set is determined by performing graph convolution and graph attention mechanism on the graph structure of the point in the reconstructed point set.

Here, the preset network model can be a deep learning-based neural network model. In embodiments of the disclosure, the preset network model can also be referred to as a PCQEN model. The model at least includes a graph attention mechanism module and a graph convolutional module, so as to implement graph convolution and graph attention mechanism on the graph structure of the point in the reconstructed point set.

In an embodiment, the graph attention mechanism module can include a first graph attention mechanism module and a second graph attention mechanism module, and the graph convolutional module can include a first graph convolutional module, a second graph convolutional module, a third graph convolutional module, and a fourth graph convolutional module. In addition, the preset network model can further include a first pooling module, a second pooling module, a first concatenating module, a second concatenating module, a third concatenating module, and an addition module.

A first input end of the first graph attention mechanism module is used for receiving the geometry information, and a second input end of the first graph attention mechanism module is used for receiving the reconstructed value of the attribute to-be-processed.

A first output end of the first graph attention mechanism module is connected to an input end of the first pooling module, an output end of the first pooling module is connected to an input end of the first graph convolutional module, and an output end of the first graph convolutional module is connected to a first input end of the first concatenating module.

A second output end of the first graph attention mechanism module is connected to a first input end of the second concatenating module, a second input end of the second concatenating module is used for receiving the reconstructed value of the attribute to-be-processed, and an output end of the second concatenating module is connected to an input end of the second graph convolutional module.

A first input end of the second graph attention mechanism module is used for receiving the geometry information, and a second input end of the second graph attention mechanism module is connected to an output end of the second graph convolutional module, a first output end of the second graph attention mechanism module is connected to an input end of the second pooling module, and an output end of the second pooling module is connected to a second input end of the first concatenating module.

A second output end of the second graph attention mechanism module is connected to a first input end of the third concatenating module, a second input end of the third concatenating module is connected to an output end of the second graph convolutional module, an output end of the third concatenating module is connected to an input end of the third graph convolutional module, and an output end of the third graph convolutional module is connected to a third input end of the first concatenating module, and the output end of the second graph convolutional module is also connected to a fourth input end of the first concatenating module.

An output end of the first concatenating module is connected to an input end of the fourth graph convolutional module, an output end of the fourth graph convolutional module is connected to a first input end of the addition module, a second input end of the addition module is used for receiving the reconstructed value of the attribute to-be-processed, and an output end of the addition module is used for outputting the processed value of the attribute to-be-processed.

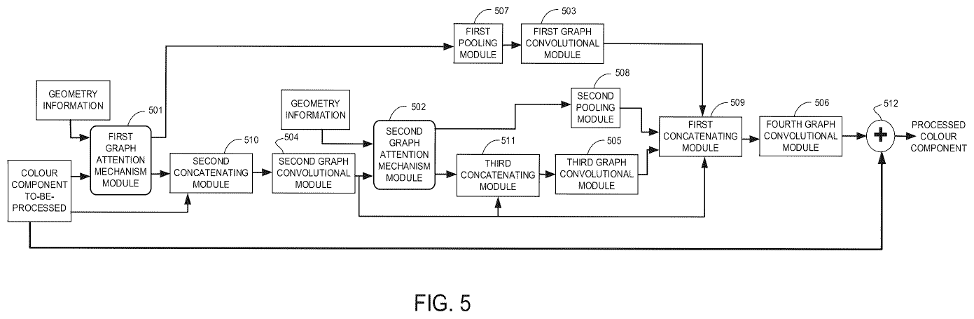

Referring to FIG. 5, FIG. 5 is a schematic diagram illustrating a network structure of a preset network model provided in embodiments of the disclosure. As illustrated in FIG. 5, the preset network model can include: a first graph attention mechanism module 501, a second graph attention mechanism module 502, a first graph convolutional module 503, a second graph convolutional module 504, a third graph convolutional module 505, a fourth graph convolutional module 506, a first pooling module 507, a second pooling module 508, a first concatenating module 509, a second concatenating module 510, a third concatenating module 511, and an addition module 512. For the connection relationship between these modules, reference can be made to FIG. 5.

The first graph attention mechanism module 501 has the same structure as the second graph attention mechanism module 502. The first graph convolutional module 503, the second graph convolutional module 504, the third graph convolutional module 505, and the fourth graph convolutional module 506 can each include at least one convolutional layer for feature extraction, where a kernel of the convolutional layer can be 1×1. The first pooling module 507 and the second pooling module 508 can each include a max pooling layer, and with aid of the max pooling layer, it is possible to focus on the most important neighbor information. The first concatenating module 509, the second concatenating module 510, and the third concatenating module 511 are mainly used for feature concatenation (which mainly refers to concatenation over channels). By repeatedly concatenating existing features with previous features, it is more conducive to taking into account global features and local features as well as features with different granularities and establishing connections between different layers. The addition module 512 is mainly used for performing addition calculation on the residual value of the attribute to-be-processed and the reconstructed value of the attribute to-be-processed after obtaining the residual value of the attribute to-be-processed, so as to obtain the processed value of the attribute to-be-processed. As such, attribute information of the processed point cloud can be similar to that of the original point cloud as much as possible, thereby realizing quality enhancement.

In addition, the first graph convolutional module 503 can include three convolutional layers, where the number of channels in the three convolutional layers is 64, 64, and 64 in sequence. The second graph convolutional module 504 can include three convolutional layers, where the number of channels in the three convolutional layers is 128, 64, and 64 in sequence. The third graph convolutional module 505 can also include three convolutional layers, where the number of channels in the three convolutional layers is 256, 128, and 256 in sequence. The fourth graph convolutional module 506 can include three convolutional layers, where the number of channels in the three convolutional layers is 256, 128, and 1 in sequence.

Further, in embodiments of the disclosure, a batch normalization (BatchNormalization, BatchNorm) layer and an activation layer can be added following the convolutional layer, so as to accelerate convergence and introduce nonlinear characteristics. Therefore, in some embodiments, each of the first graph convolutional module 503, the second graph convolutional module 504, the third graph convolutional module 505, and the fourth graph convolutional module 506 further includes at least one batch normalization layer and at least one activation layer, where the batch normalization layer and the activation layer are connected subsequent to the convolutional layer. However, it should be noted that, the last convolutional layer in the fourth graph convolutional module 506 may not be followed by the batch normalization layer and activation layer.

In embodiments of the disclosure, the activation layer can include an activation function. Here, the activation function can be a rectified linear unit (ReLU), and is also referred to as a linear rectifier function, which is an activation function commonly used in artificial neural networks and generally refers to a nonlinear function represented by a ramp function and a variant thereof. That is, the activation function can also be other variants of the linear rectifier function that are obtained based on the ramp function and widely applied to deep learning, for example, a Leaky ReLU function and a Noisy ReLU function. Exemplarily, except the last layer, each of the other 1×1 convolutional layers is followed by the BatchNorm layer to accelerate convergence and prevent overfitting, and then is followed by a LeakyReLU activation function with a slope of 0.2 to introduce nonlinearity.

In an embodiment, in S402, the geometry information and the reconstructed value of the attribute to-be-processed of the point in the reconstructed point set can be input into the preset network model and the processed value of the attribute to-be-processed of the point in the reconstructed point set can be determined based on the preset network model as follows. Through the first graph attention mechanism module 501, feature extraction is performed on the geometry information and the reconstructed value of the attribute to-be-processed, to obtain a first graph feature and a first attention feature. Through the first pooling module 507 and the first graph convolutional module 503, feature extraction is performed on the first graph feature to obtain a second graph feature. Through the second concatenating module 510, the first attention feature and the reconstructed value of the attribute to-be-processed are concatenated to obtain a first concatenated attention feature. Through the second graph convolutional module 504, feature extraction is performed on the first concatenated attention feature to obtain a second attention feature. Through the second graph attention mechanism module 502, feature extraction is performed on the geometry information and the second attention feature to obtain a third graph feature and a third attention feature. Through the second pooling module 508, feature extraction is performed on the third graph feature to obtain a fourth graph feature. Through the third concatenating module 511, the third attention feature and the second attention feature are concatenated to obtain a second concatenated attention feature. Through the third graph convolutional module 505, feature extraction is performed on the second concatenated attention feature to obtain a fourth attention feature. Through the first concatenating module 509, the second graph feature, the fourth graph feature, the second attention feature, and the fourth attention feature are concatenated to obtain a target feature. Through the fourth graph convolutional module 506, convolution is performed on the target feature to obtain a residual value of the attribute to-be-processed of the point in the reconstructed point set. Through the addition module 512, addition calculation is performed on the residual value of the attribute to-be-processed of the point in the reconstructed point set and the reconstructed value of the attribute to-be-processed, to obtain the processed value of the attribute to-be-processed of the point in the reconstructed point set.

It should be noted that, in embodiments of the disclosure, the reconstructed point set (i.e. patch) includes n points, and the input of the preset network model is geometry information and single-colour-component information of the n points. The geometry information can be represented by p, and the size of the geometry information is n×3. The single-colour-component information is represented by c, and the size of the single-colour-component information is n×1. A graph structure with the neighborhood size of k can be constructed through KNN search by using the geometry information as an auxiliary input. In this way, the first graph feature, which is obtained through the first graph attention mechanism module 501, is represented by g₁, and the size of the first graph feature can be n×k×64. The first attention feature is represented by a₁, and the size of the first attention feature can be n×64. The second graph feature, which is obtained after g₁ passes through the first pooling module 507 and is then subject to convolution over channels of which the number is {64, 64, 64} in the first graph convolutional module 503, is represented by g₂, and the size of the second graph feature can be n×64. The second attention feature, which is obtained after a₁ is concatenated with the input colour component c in the second concatenating module 510 and then subject to convolution over channels of which the number is {128, 64, 64} in the second graph convolutional module 504, is represented by a₂, and the size of the second attention feature can be n×64. Further, the third graph feature, which is obtained through the second graph attention mechanism module 502, is represented by g₃, and the size of the third graph feature can be n×k×256. The third attention feature is represented by a₃, and the size of the third attention feature can be n×256. The fourth graph feature, which is obtained after g₃ passes through the second pooling module 508, is represented by g₄, and the size of the fourth graph feature is n×256. The fourth attention feature, which is obtained after a₃ is concatenated with a₂ in the third concatenating module 511 and then subject to convolution over channels of which the number is {256, 128, 256} in the third graph convolutional module 505, is represented by a₄, and the size of the fourth attention feature is n×256. The residual value of the attribute to-be-processed, which is obtained after g₂, g₄, and a₂ are concatenated with a₄ in the first concatenating module 509 and then subject to convolution over channels of which the number is {256, 128, 1} in the fourth graph convolutional module 506, is represented by r. Addition calculation is performed on r and the input colour component c in the addition module 512, to obtain a processed colour component finally output, that is, a quality-enhanced colour component c′.

Here, in order to take full advantage of a convolutional neural network (CNN), a point cloud network (PointNet) provides an efficient approach to learn shape features directly on an unordered 3D point cloud and has achieved competitive performance. However, local feature that is helpful towards better contextual learning is not considered. Meanwhile, attention mechanism shows efficiency in capturing node representation on graph-based data through attention to neighboring nodes. Therefore, a new neural network for point cloud, namely graph attention based point neural network (GAPnet), can be proposed to learn local geometric representations by embedding graph attention mechanism within MLP layers. In embodiments of the disclosure, a GAPLayer module is introduced here, to learn attention features for each point by highlighting different attention weights on neighborhood. Secondly, in order to exploit sufficient features, a multi-head mechanism is employed to allow the GAPLayer module to aggregate different features from single heads. Thirdly, it is also proposed that an attention pooling layer is employed over neighbor networks to capture local signature so as to enhance network robustness. Finally, in the GAPNet, stacked MLP layers are applied to attention features and graph features to fully extract input information of the attribute to-be-processed.

That is, in embodiments of the disclosure, the first graph attention mechanism module 501 has the same structure as the second graph attention mechanism module 502. The first graph attention mechanism module 501 and the second graph attention mechanism module 502 can each include a fourth concatenating module and a preset number of graph attention mechanism sub-modules, where the graph attention mechanism sub-module can be a single-head GAPLayer module. In this way, the graph attention mechanism module that includes the preset number of single-head GAPLayer modules is a multi-head mechanism. That is, the multi-head GAPLayer (which can be referred to as “GAPLayer module” for short) refers to the first graph attention mechanism module 501 or the second graph attention mechanism module 502.

In some embodiments, the internal connection relationship within each of the first graph attention mechanism module 501 and the second graph attention mechanism module 502 is described as follows.

In the first graph attention mechanism module 501, an input end of each of the preset number of graph attention mechanism sub-modules is used for receiving the geometry information and the reconstructed value of the attribute to-be-processed, an output end of each of the preset number of graph attention mechanism sub-modules is connected to an input end of the fourth concatenating module, and an output end of the fourth concatenating module is used for outputting the first graph feature and the first attention feature.

In the second graph attention mechanism module 502, an input end of each of the preset number of graph attention mechanism sub-modules is used for receiving the geometry information and the second attention feature, an output end of each of the preset number of graph attention mechanism sub-modules is connected to an input end of the fourth concatenating module, and an output end of the fourth concatenating module is used for outputting the third graph feature and the third attention feature.

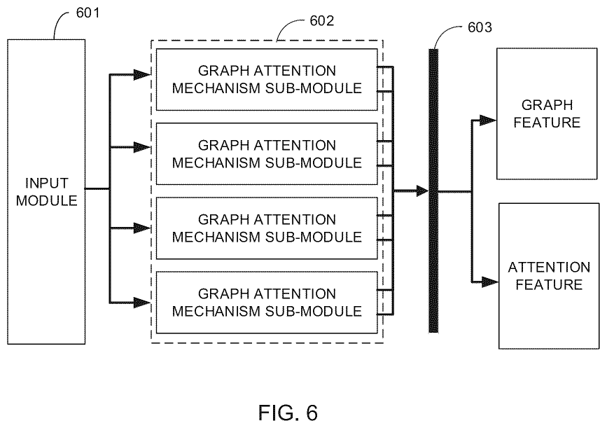

Referring to FIG. 6, FIG. 6 is a schematic diagram illustrating a network structure of a graph attention mechanism module provided in embodiments of the disclosure. As illustrated in FIG. 6, the graph attention mechanism module can include an input module 601, four graph attention mechanism sub-modules 602, and a fourth concatenating module 603. The input module 601 is used for receiving the geometry information and input information. The geometry information is a 3D feature, and the dimension of the input information (for example, one colour component or multiple colour components) is represented by F, and therefore the input information can be represented by n×(F+3). In addition, the output can include a graph feature and an attention feature, where the size of the graph feature is represented by n×k×|4×F′|, and the size of the attention feature is represented by n×|4×F′|.

Here, in order to obtain sufficient structure information and a stable network, by concatenating the outputs of the four graph attention mechanism sub-modules 602 together via the fourth concatenating module 603, multi-attention features and multi-graph features can be obtained. If the graph attention mechanism module illustrated in FIG. 6 is the first graph attention mechanism module 501, the input module 601 receives the geometry information and the reconstructed value of the attribute to-be-processed, the output multi-graph features are the first graph feature, and the output multi-attention features are the first attention feature. If the graph attention mechanism module illustrated in FIG. 6 is the second graph attention mechanism module 502, the input module 601 receives the geometry information and the second attention feature, the output multi-graph features are the third graph feature, and the output multi-attention features are the third attention feature.

In some embodiments, taking the first graph attention mechanism module 501 as an example, feature extraction can be performed on the geometry information and the reconstructed value of the attribute to-be-processed through the first graph attention mechanism module to obtain the first graph feature and the first attention feature as follows. The geometry information and the reconstructed value of the attribute to-be-processed are input into the graph attention mechanism sub-module to obtain an initial graph feature and an initial attention feature. A preset number of initial graph features and a preset number of initial attention features are obtained through the preset number of graph attention mechanism sub-modules. The preset number of initial graph features are concatenated through the fourth concatenating module to obtain the first graph feature. The preset number of initial attention features are concatenated through the fourth concatenating module to obtain the first attention feature.

In an embodiment, the graph attention mechanism sub-module at least includes multiple MLP modules. Accordingly, the geometry information and the reconstructed value of the attribute to-be-processed can be input into the graph attention mechanism sub-module to obtain the initial graph feature and the initial attention feature as follows. A graph structure of the point in the reconstructed point set is obtained by performing graph construction based on the reconstructed value of the attribute to-be-processed additionally with the geometry information. Feature extraction is performed on the graph structure through at least one of the MLP modules to obtain the initial graph feature. Feature extraction is performed on the reconstructed value of the attribute to-be-processed through at least one of the MLP modules to obtain first intermediate feature information. Feature extraction is performed on the initial graph feature through at least one of the MLP modules to obtain second intermediate feature information. Feature aggregation is performed on the first intermediate feature information and the second intermediate feature information by using a first preset function, to obtain an attention coefficient. Normalization is performed on the attention coefficient by using a second preset function, to obtain a feature weight. The initial attention feature is obtained according to the feature weight and the initial graph feature.

It should be noted that, in embodiments of the disclosure, with regard to extraction of the initial graph feature, the initial graph feature can be obtained by performing feature extraction on the graph structure through at least one MLP module, and exemplarily, can be obtained by performing feature extraction on the graph structure with one MLP module. With regard to extraction of the first intermediate feature information, the first intermediate feature information can be obtained by performing feature extraction on the reconstructed value of the attribute to-be-processed through at least one MLP module, and exemplarily, can be obtained by performing feature extraction on the reconstructed value of the attribute to-be-processed through two MLP modules. With regard to extraction of the second intermediate feature information, the second intermediate feature information can be obtained by performing feature extraction on the initial graph feature through at least one MLP module, and exemplarily, can be obtained by performing feature extraction on the initial graph feature through one MLP module. It should be noted that, the number of MLP modules is not specifically limited herein.

It should also be noted that, in embodiments of the disclosure, the first preset function is different from the second preset function. The first preset function is a nonlinear activation function, for example, a LeakyReLU function; and the second preset function is a normalized exponential function, for example, a softmax function. Here, the softmax function can “convert” a K-dimension vector z of arbitrary real numbers into another K-dimension vector σ(z), such that the range of each element is within (0, 1), and the sum of all the elements is 1. Briefly speaking, the softmax function is mainly used for normalization.

It should also be noted that, in terms of obtaining the initial attention feature according to the feature weight and the initial graph feature, linear combination operation can be performed according to the feature weight and the initial graph feature to generate the initial attention feature. Here, the initial graph feature is n×k×F′, the feature weight is n×1×k, and the initial attention feature obtained through linear combination operation is n×F′.

It can be understood that, in embodiments of the disclosure, with aid of the graph attention mechanism module, after constructing the graph structure, for each point, a neighborhood feature that is more important to the point is given a greater weight by means of the attention structure, so as to better perform feature extraction through graph convolution. In the first graph attention mechanism module, additional input of the geometry information is required to assist in constructing the graph structure. The first graph attention mechanism module can be formed by four graph attention mechanism sub-modules, and accordingly, the final output is obtained by concatenating outputs of all the graph attention mechanism sub-modules. In the graph attention mechanism sub-module, after constructing a graph structure with the neighborhood size of k (for example, k=20) through KNN search, graph convolution is performed on an edge feature in the graph structure to obtain the output of one of the graph attention mechanism sub-modules, i.e. the initial graph feature. On the other hand, an input feature after passing through two MLP layers and a graph feature after passing through one more MLP layer are aggregated and then pass through an activation function LeakyReLU, and a k-dimension feature weight is obtained through normalization by using a softmax function. By applying the weight to the k-neighborhood (graph feature) of the current point, the other output (the initial attention feature) can be obtained.

In another embodiment, taking the second graph attention mechanism module 502 as an example, feature extraction can be performed on the geometry information and the second attention feature through the second graph attention mechanism module to obtain the third graph feature and the third attention feature as follows. The geometry information and the second attention feature are input into the graph attention mechanism sub-module, to obtain a second initial graph feature and a second initial attention feature. A preset number of second initial graph features and a preset number of second initial attention features are obtained through the preset number of graph attention mechanism sub-modules. In this way, the preset number of second initial graph features are concatenated through the fourth concatenating module to obtain the third graph feature, and the preset number of second initial attention features are concatenated through the fourth concatenating module to obtain the third attention feature.

Further, in some embodiments, for the graph attention mechanism sub-module in the second graph attention mechanism module, the geometry information and the second attention feature can be input into the graph attention mechanism sub-module to obtain the graph feature and the attention feature as follows. A second graph structure is obtained by performing graph construction based on the second attention feature additionally with the geometry information. Feature extraction is performed on the second graph structure through at least one MLP module, to obtain the second initial graph feature. Feature extraction is performed on the second attention feature through at least one MLP module, to obtain third intermediate feature information. Feature extraction is performed on the second initial graph feature through at least one MLP module, to obtain fourth intermediate feature information. Feature aggregation is performed on the third intermediate feature information and the fourth intermediate feature information by using the first preset function, to obtain a second attention coefficient. Normalization is performed on the second attention coefficient by using the second preset function, to obtain a second feature weight. The second initial attention feature is obtained according to the second feature weight and the second initial graph feature.

In this way, based on the preset network model illustrated in FIG. 5, the input of the preset network model is the geometry information and the reconstructed value of the attribute to-be-processed of the point in the reconstructed point set. By constructing a graph structure for each point in the reconstructed point set and extracting the graph feature through graph convolution and graph attention mechanism, a residual between the reconstructed point cloud and the original point cloud is learned. Finally, the output of the preset network model is the processed value of the attribute to-be-processed of the point in the reconstructed point set.

In some embodiments, in S403, the processed point cloud corresponding to the reconstructed point cloud can be determined according to the processed value of the attribute to-be-processed of the point in the reconstructed point set as follows. A target set corresponding to the reconstructed point set is determined according to the processed value of the attribute to-be-processed of the point in the reconstructed point set. The processed point cloud is determined according to the target set.

It should be noted that, in embodiments of the disclosure, one or more patches (i.e. reconstructed point sets) can be obtained by performing patch extraction on the reconstructed point cloud. For a patch, after the attribute to-be-processed of the point in the reconstructed point set is processed through the preset network model, the processed value of the attribute to-be-processed of the point in the reconstructed point set is obtained. Then, the reconstructed value of the attribute to-be-processed of the point in the reconstructed point set is updated with the processed value of the attribute to-be-processed, and as such, the target set corresponding to the reconstructed point set can be obtained, thereby determining the processed point cloud.

Further, in some embodiments, the processed point cloud can be determined according to the target set as follows. If the key point is multiple key points, extraction is performed on the reconstructed point cloud according to the multiple key points to obtain multiple reconstructed point sets. After determining target sets corresponding to the multiple reconstructed point sets, the processed point cloud is determined by performing fusion according to the multiple target sets obtained.

It should also be noted that, in embodiments of the disclosure, one or more key points can be obtained through FPS, and each key point corresponds to one reconstructed point set. In this way, if the key point is implemented as multiple key points, multiple reconstructed point sets can be obtained. After obtaining the target set corresponding to one reconstructed point set, target sets corresponding respectively to the multiple reconstructed point sets can be obtained through the same operation. Then, patch fusion is performed according to the multiple target sets obtained, and as such, the processed point cloud can be determined.

In an embodiment, the processed point cloud can be determined by performing fusion according to the multiple obtained target sets as follows. If at least two of the multiple target sets include a processed value of an attribute to-be-processed of a first point, the mean value of the obtained at least two processed values is calculated to determine a processed value of the attribute to-be-processed of the first point in the processed point cloud. If none of the multiple target sets includes the processed value of the attribute to-be-processed of the first point, a reconstructed value of the attribute to-be-processed of the first point in the reconstructed point cloud is determined as the processed value of the attribute to-be-processed of the first point in the processed point cloud. The first point is any one point in the reconstructed point cloud.

It should be noted that, in embodiments of the disclosure, when constructing the reconstructed point set, some points in the reconstructed point cloud may not have been extracted, while some points in the reconstructed point cloud have been extracted repeatedly and as a result such points are repeatedly fed into the preset network model. Therefore, for a point that has not yet been extracted, the reconstructed value of the point can be reserved, while for a point that has been extracted repeatedly, the mean value thereof can be calculated as the final value. In this way, the processed point cloud with enhanced quality can be obtained after all the reconstructed point sets are fused.

It should also be noted that, in embodiments of the disclosure, the point cloud is usually represented by an RGB colour space, and if a point cloud is represented by YUV components, it is difficult to realize visualization of the point cloud by using an existing application. Therefore, after determining the processed point cloud corresponding to the reconstructed point cloud, the method can further include the following. If a colour component does not comply with an RGB colour space (for example, a YUV colour space, a YCbCr colour space, and the like), colour space conversion is performed on the colour component of a point in the processed point cloud, to make the converted colour component comply with the RGB colour space. In this way, if the colour component of the point in the processed point cloud complies with the YUV colour space, the colour component of the point in the processed point cloud needs to be converted into the RGB colour space from the YUV colour space, and then the reconstructed point cloud is updated with the processed point cloud.

Further, the preset network model is obtained by training a preset PCQEN based on deep learning. Therefore, in some embodiments, the method can further include the following. A training sample set is determined, where the training sample set includes at least one point-cloud sequence. Extraction is performed on the at least one point-cloud sequence to obtain multiple sample point sets. In a preset bit-rate, model training is performed on an initial model by using geometry information and an original value of an attribute to-be-processed of multiple sample point sets, to determine the preset network model.

It should be noted that, for the training sample set, the following sequences can be selected from the existing point-cloud sequences: Andrew.ply, boxer_viewdep_vox12.ply, David.ply, exercise_vox11_ 00000040.ply, longdress_vox10_1100.ply, longdress_vox10_1200.ply, longdress_vox10_1300.ply, model_vox11_00000035.ply, Phil.ply, queen_0050.ply, queen_0150.ply, redandblack_vox10_1450.ply, redandblack_vox10_1500.ply, Ricardo.ply, Sarah.ply, thaidancer_viewdep_vox12.ply. Then, a patch(es) (i.e. sample point set) is extracted from each of the above point-cloud sequences, and the number of patches extracted from each point-cloud sequence is:

$$round ( \frac{N \times 3}{2048} ) ,$$

where N is the number of points in the point-cloud sequence. When performing model training, the total number of patches can be 34848, and these patches are fed into the initial model for training, so as to obtain the preset network model.

It should also be noted that, in embodiments of the disclosure, the initial model is related to a bit-rate, different bit-rates can correspond to different initial models, and different colour components can also correspond to different initial models. In this way, with regard to six bit-rates r01˜r06 and three colour components Y/U/V in each bit-rate, there are totally 18 initial models to be trained, and thus 18 preset network models can be obtained. That is, different bit-rates or different colour components correspond to different preset network models.

In addition, during training, an adam optimizer with a learning rate of 0.004 can be used. The learning rate decays to 0.25 of its previous value every 60 epochs, the number of samples per batch (i.e. batch size) is 16, and the total number of epochs is 200. The process in which a complete dataset passes through the preset network model once and returns once is referred to as one epoch, i.e. one epoch is equivalent to the process of performing training on all training samples once. The batch size is the data amount in each batch input into the preset network model. For example, if there are 16 pieces of data in a batch, then the batch size is 16.

After the preset network model is obtained through training, network test can be performed by using a testing point-cloud sequence. The testing point-cloud sequence can be: basketball_player_vox11_00000200.ply, dancer_vox11_00000001.ply, loot_vox10_1200.ply, soldier_vox10_0690.ply. In the test, the input is the whole point-cloud sequence. In each bit-rate, patch extraction is performed on each point-cloud sequence, then the patch(es) is input to the trained preset network model to perform quality enhancement on each of Y/U/V colour components. Finally, the processed patches are fused to generate a point cloud with enhanced quality. That is, embodiments of the disclosure propose a technology for post-processing of a colour attribute of a reconstructed point cloud obtained through G-PCC decoding, in which model training is performed on a preset PCQEN based on deep learning, and the performance of the network model is tested by using a testing set.

Further, in embodiments of the disclosure, for the preset network model illustrated in FIG. 5, instead of inputting a single colour component and geometry information, all the three colour components Y/U/V and geometry information can be used as inputs of the preset network model instead of processing only one colour component each time. In this way, time complexity can be reduced, but the effect will be slightly degraded.

Further, in embodiments of the disclosure, the application scope of the decoding method can also be extended, and can be used for post-processing after coding of a multi-frame/dynamic point cloud in addition to processing a single-frame point cloud. Exemplarily, in InterEM V5.0 of the G-PCC framework, there is an inter-prediction operation on attribute information, and therefore, the quality of the next frame depends greatly on the current frame. Thus, in embodiments of the disclosure, with aid of the preset network model, a reflectance attribute of a reconstructed point cloud, which is obtained through decoding of each frame of point cloud in a multi-frame point cloud, can be post-processed, and the reconstructed point cloud can be replaced with a processed point cloud with enhanced quality in order for inter prediction, which is possible to significantly improve attribute reconstruction quality of the next frame of point cloud.

Embodiments of the disclosure provide a decoding method. The reconstructed point set is determined based on the reconstructed point cloud, where the reconstructed point set includes at least one point. The geometry information and the reconstructed value of the attribute to-be-processed of the point in the reconstructed point set are input into the preset network model, and the processed value of the attribute to-be-processed of the point in the reconstructed point set is determined based on the preset network model. The processed point cloud corresponding to the reconstructed point cloud is determined according to the processed value of the attribute to-be-processed of the point in the reconstructed point set. In this way, by performing quality enhancement on attribute information of the reconstructed point cloud based on the preset network model, it is possible not only to perform training on different network models with regard to various bit-rates and various colour components based on the network framework so as to effectively ensure quality enhancement effect of the point cloud under various conditions, but also to realize an end-to-end operation. On the other hand, by performing patch extraction and patch fusion on the reconstructed point cloud, it is possible to realize patching of the point cloud, thereby effectively reducing resource consumption. Through repeated point extraction, processing, and mean calculation, it is possible to improve effect and robustness of the network model. In addition, by performing quality enhancement on the attribute information of the reconstructed point cloud based on the preset network model, it is possible to make the processed point cloud have clearer texture and more natural transition, which can effectively improve quality of the point cloud and visual effect, thereby improving compression performance of the point cloud.

In another embodiment of the disclosure, based on the decoding method described in the foregoing embodiments, embodiments of the disclosure propose a graph-based PCQEN (which can be represented by a PCQEN model). In the model, a graph structure is constructed for each point, and a graph feature is extracted through graph convolution and graph attention mechanism, so as to learn a residual between a reconstructed point cloud and an original point cloud, such that that the reconstructed point cloud is similar to the original point cloud as much as possible, thereby realizing quality enhancement.

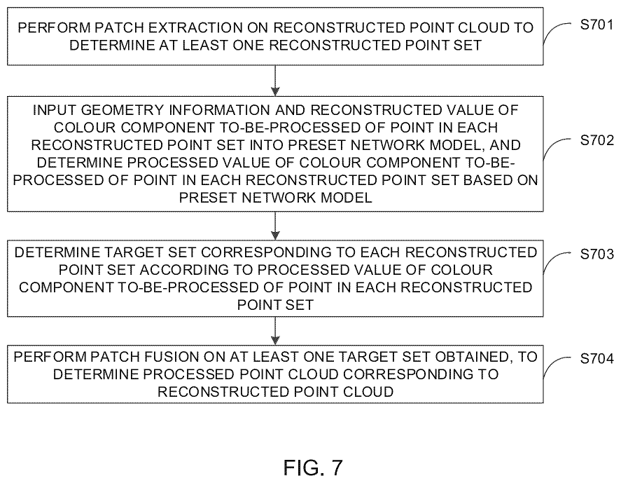

Referring to FIG. 7, FIG. 7 is a schematic flowchart of a detailed decoding method provided in embodiments of the disclosure. As illustrated in FIG. 7, the method can include the following.

S701, patch extraction is performed on a reconstructed point cloud to determine at least one reconstructed point set.

S702, geometry information and a reconstructed value of a colour component to-be-processed of a point in each reconstructed point set are input into a preset network model, and a processed value of the colour component to-be-processed of the point in each reconstructed point set is output by the preset network model.

S703, a target set corresponding to each reconstructed point set is determined according to the processed value of the colour component to-be-processed of the point in each reconstructed point set.

S704, patch fusion is performed on the at least one target set obtained, to determine a processed point cloud corresponding to the reconstructed point cloud.

It should be noted that, in embodiments of the disclosure, a colour component is taken as an example of the attribute information. After S701, if the colour component of the point in the reconstructed point set does not comply with a YUV colour space, colour space conversion needs to be performed on the colour component of the point in the reconstructed point set, so that the converted colour component complies with the YUV colour space. Then, considering that a point cloud is usually represented by an RGB colour space and it is difficult to realize visualization of the point cloud by using an existing application if the point cloud is presented by YUV components, after S704, if a colour component of a point in the processed point cloud does not comply the RGB colour space, colour space conversion needs to be performed on the colour component of the point in the processed point cloud, so that the converted colour component complies with the RGB colour space.

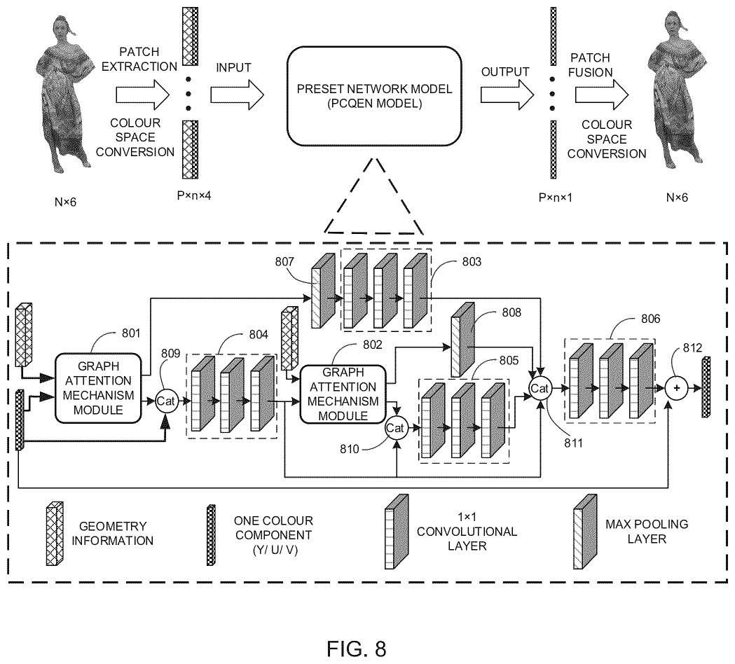

In an embodiment, a flowchart of the technical solutions and a network framework of the preset network model are illustrated in FIG. 8. As illustrated in FIG. 8, the preset network model can include two graph attention mechanism modules (801, 802), four graph convolutional modules (803, 804, 805, 806), two pooling modules (807, 808), three concatenating modules (809, 810, 811), and one addition module 812. Each graph convolutional module at least can include three 1×1 convolutional layers, and each pooling module at least can include a max pooling layer.

In addition, in FIG. 8, the size of the reconstructed point cloud is N×6, where N represents the number of points in the reconstructed point cloud, and 6 represents three-dimension geometry information and three-dimension attribute information (for example, three colour components Y/U/V). An input of the preset network model is P×n×4, where P represents the number of reconstructed point sets (i.e. patches) extracted, n represents the number of points in each patch, and 4 represents three-dimension geometry information and one-dimension attribute information (i.e. a single colour component). An output of the preset network model is P×n×1, where 1 represents a colour component with enhanced quality. Finally, patch fusion is performed on the output of the preset network model, so as to obtain an N×6 processed point cloud.

Specifically, in embodiments of the disclosure, for the reconstructed point cloud obtained through G-PCC decoding, patch extraction is firstly performed, where each patch can include n points, for example, n=2048. Here, P key points are obtained through FPS, where

$$P = round ( \frac{N \times γ}{n} ) ,$$

N is the number of points in the reconstructed point cloud, and γ is a duplication-rate factor and is used to control the average number of times that each point is fed into the preset network model, for example, γ=3. Then, KNN search where K=n is performed for each key point, so that P patches with the size of n can be obtained, where each point has three-dimension geometry information and three-dimension colour component information. Further, colour space conversion is performed on the colour component information to convert the colour component information into YUV colour component information from an RGB colour space, and a colour component (e. g. a Y component) which requires quality enhancement is extracted and input into the preset network model (a PCQEN model) together with the three-dimension geometry information. An output of the model is values of the quality-enhanced Y component of n points, and these values will replace values of the Y component in the original patch (i.e. other components remain unchanged), so as to obtain a patch of which a single colour component is quality-enhanced. The other two components can also be fed into corresponding PCQEN models for quality enhancement, and finally, patch fusion is performed so as to obtain the processed point cloud. It should be noted that, during patch construction, some points in the reconstructed point cloud may not have been extracted while some points in the reconstructed point cloud have been fed into the PCQEN model repeatedly. Therefore, for a point that has not yet been extracted, the reconstructed value of the point can be reserved; while for a point that has been extracted repeatedly, the mean value thereof can be calculated as the final value. In this way, the processed point cloud with enhanced quality can be obtained after all the patches are fused.

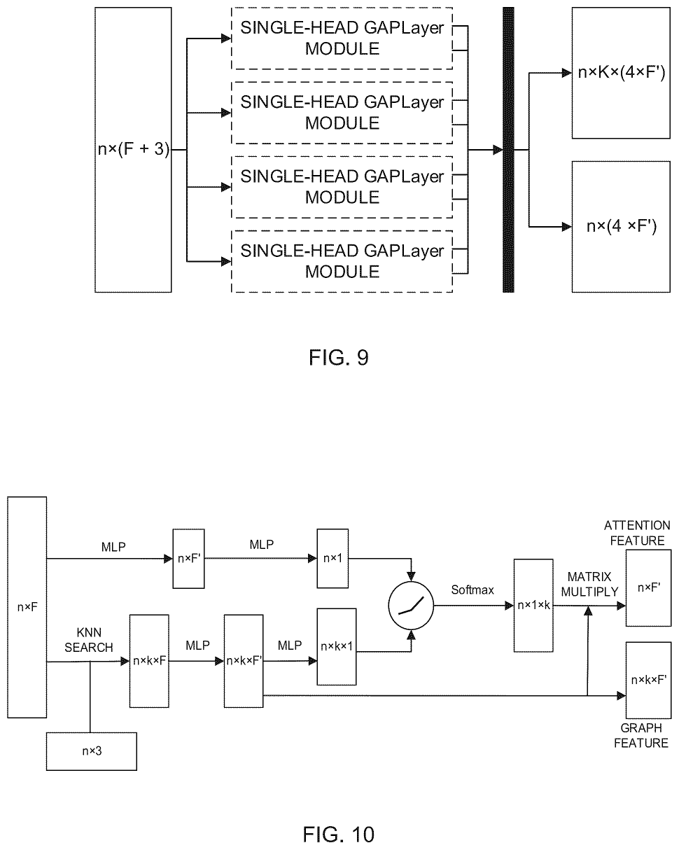

Further, with regard to the PCQEN model, the total amount of parameters of the network can be set to 829121, and the size of the model is 7.91 MegaBytes (MB). In the design of the model, a graph attention mechanism module (GAPLayer module) is involved. The module is a graph-based attention mechanism module. After a graph structure is constructed, for each point, a neighborhood feature that is more important to the point is given a greater weight with aid of the designed attention structure, so as to better perform feature extraction through graph convolution. FIG. 9 is a schematic diagram illustrating a network framework of a GAPLayer module provided in embodiments of the disclosure, and FIG. 10 is a schematic diagram illustrating a network framework of a single-head GAPLayer module provided in embodiments of the disclosure. In the GAPLayer module, additional input of geometry information is required to assist in constructing a graph structure. Here, the GAPLayer module can be formed by four single-head GAPLayer modules, and accordingly, the final output is obtained by concatenating all the outputs. In the single-head GAPLayer module, after constructing a graph with the neighborhood size of k (for example, k=20) through KNN search, graph convolution is performed on an edge feature to obtain the output of one of the single-head GAPLayer modules, that is, graph feature. On the other hand, an input feature after passing through two MLP layers and a graph feature after passing through one more MLP layer are aggregated and then pass through an activation function (for example, a LeakyReLU function), and a k-dimension feature weight is obtained through normalization by using a softmax function. By applying the feature weight to the k-neighborhood (graph feature) of the current point, an attention feature can be obtained. Finally, the graph features of four single-heads are concatenated and the attention features of four single-heads are concatenated to obtain the outputs of the GAPLayer module.

In this way, based on the framework illustrated in FIG. 8, the input of the whole network model is single-colour-component information c (n×1) and geometry information p (n×3) of a patch including n points. After passing through one GAPLayer module (the number F′ of single-head output channels is set to 16), a graph feature g₁ (n×k×64) and an attention feature a₁ (n×64) can be obtained, that is, g1, a1=GAPLayer1(c, p). Then, g₁ passes through a max pooling payer and then is subject to 1×1 convolution over channels of which the number is {64, 64, 64}, and thus g₂(n×64) can be obtained, that is, g2=MaxPooling(conv1(g1)). a₁ and the input colour component c are concatenated and then subject to 1×1 convolution over channels of which the number is {128, 64, 64}, and thus a₂ (n×64) is obtained, that is, a2=conv2(concat(a1, c)). After a₂ and p are input into a 2^{nd} GAPLayer module (the number F′ of single-head output channels is set to 64), a graph feature g₃ (n×k×256) and an attention feature a₃ (n×256) can be obtained, that is, g3, a3=GAPLayer2(a2, p). Further, after g₃ passes through a max pooling payer, g₄ (n×256) is obtained, that is, g4=MaxPooling(g3). a₃ and a₂ are concatenated and then subject to 1×1 convolution over channels of which the number is {256, 128, 256}, and thus a₄ (n×256) is obtained, that is, a4=conv3(concat(a3, a2)). Finally, g₂, g₄, a₂, and a₄ are concatenated and then subject to 1×1 convolution over channels of which the number is {256, 128, 1}, and thus a residual value r is obtained, that is, r=conv4(concat(a4, a2, g4, g2)). Then, addition calculation is performed on r and the input colour component c to obtain a final output, namely a quality-enhanced colour component c′, that is, c′=c+r. In addition, it should be noted that, except the last layer, each of the other 1×1 convolutional layers needs to be followed by a batch normalization layer to accelerate convergence and prevent overfitting, and then is followed by an activation function (such as a LeakyReLU function with a slope of 0.2) to introduce nonlinearity.

As such, a loss function of the PCQEN model can be calculated by means of MSE, and the formula thereof is as follows:

$${L}_{MSE} = \frac{1}{n} {\sum }_{i = 0}^{n} {( {c}_{i}^{′} - {\tilde{c}}_{i} )}^{2} \qquad ( 2 )$$

where c′ᵢ represents a processed value of a colour component c of a point in the processed point cloud, and \tilde{c}ᵢ represents an original value of a colour component c of a point in the original point cloud.

Exemplarily, for a PCQEN model under a certain configuration condition, a training set of the model can be the following sequences selected from the existing point-cloud sequences: Andrew.ply, boxer_viewdep_vox12.ply, David.ply, exercise_vox11_00000040.ply, longdress_vox10_1100.ply, longdress_vox10_1200.ply, longdress_vox10_1300.ply, model_vox11_00000035.ply, Phil.ply, queen_0050.ply, queen_0150.ply, redandblack_vox10_1450.ply, redandblack_vox10_1500.ply, Ricardo.ply, Sarah.ply, thaidancer_viewdep_vox12.ply. Patch extraction is performed on each of the above point-cloud sequences, and the number of patches can be

$$round ( \frac{N \times 3}{2048} ) ,$$

where N is the number of points in the point-cloud sequence. When performing training, the total number of patches is 34848, these patches are fed into the network, and then a total of 18 network models with regard to bit-rates r01˜r06 and three colour components Y/U/V in each bit-rate are trained. In the model training, an adam optimizer with a learning rate of 0.004 can be used. The learning rate decays to 0.25 of its previous value every 60 epochs, a batch size is 16, and the total number of epochs is 200.

Further, for network test of the PCQEN model, a testing point-cloud sequence is: basketball_player_vox11_00000200.ply, dancer_vox11_00000001.ply, loot_vox10 1200.ply, soldier_vox10_0690.ply. In the test, the input is the whole point-cloud sequence. In each bit-rate, patching is performed on each point-cloud sequence, then the patch(es) is input to the trained preset network model to perform quality enhancement on each of Y/U/V components. Finally, the patches are fused to generate a point cloud with enhanced quality.

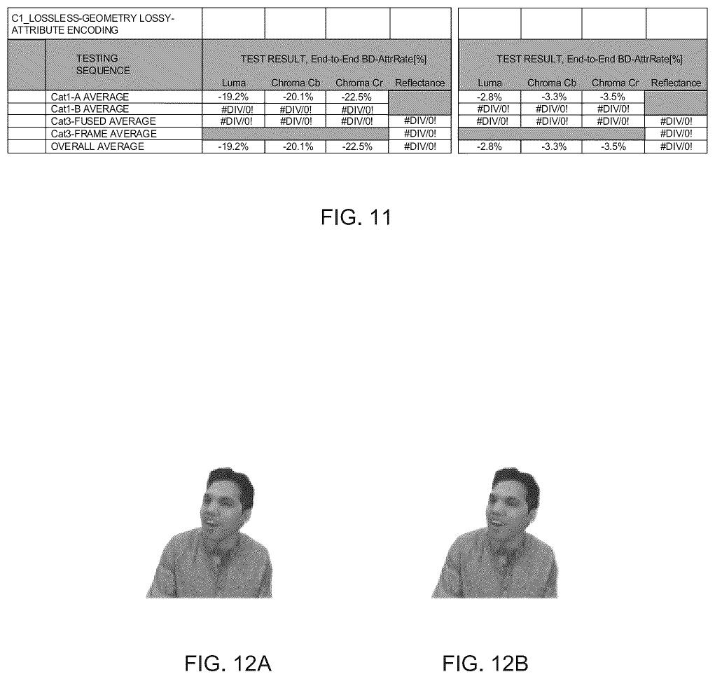

Thus, after the technical solutions of embodiments of the disclosure are implemented on a G-PCC reference software test model categories (TMC) 13 V14.0, the above testing sequences are tested under test condition CTC-C1 (RAHT attribute transform). The test results obtained are illustrated in FIG. 11 and Table 1. Table 1 shows the test results for each testing point-cloud sequence (basketball-_player_vox11-_00000200.ply, dancer_vox11-_00000001.ply, loot_vox10-_1200.ply, soldier_vox10-_0690.ply).

TABLE 1

| | Bit- | | | | |
|---|---|---|---|---|---|
| Point-cloud sequence | rate | ΔY | ΔU | ΔV | Average |
| basketball-_player_vox11-_00000200.ply | r01 | 0.407391 | 0.200248 | 0.383298 | 0.330312333 |
| | r02 | 0.62788 | 0.173422 | 0.44098 | 0.414094 |
| | r03 | 0.796994 | 0.219477 | 0.496945 | 0.504472 |
| | r04 | 0.757286 | 0.284497 | 0.576474 | 0.539419 |
| | r05 | 0.653537 | 0.390417 | 0.711308 | 0.585087333 |
| | r06 | 0.458987 | 0.434684 | 0.768687 | 0.554119333 |
| dancer_vox11-_00000001.ply | r01 | 0.569704 | 0.185664 | 0.468773 | 0.408047 |
| | r02 | 0.733281 | 0.223734 | 0.41577 | 0.457595 |
| | r03 | 0.815278 | 0.278091 | 0.596763 | 0.563377333 |
| | r04 | 0.799162 | 0.305613 | 0.675297 | 0.593357333 |
| | r05 | 0.713935 | 0.407132 | 0.763676 | 0.628247667 |
| | r06 | 0.4973 | 0.46091 | 0.809807 | 0.589339 |
| loot_vox10-_1200.ply | r01 | 0.326884 | 0.25302 | 0.315221 | 0.298375 |
| | r02 | 0.388654 | 0.313861 | 0.410963 | 0.371159333 |
| | r03 | 0.511031 | 0.563148 | 0.617027 | 0.563735333 |
| | r04 | 0.760287 | 0.703594 | 0.705852 | 0.723244333 |
| | r05 | 0.96613 | 0.91326 | 0.922503 | 0.933964333 |
| | r06 | 0.861907 | 1.09546 | 0.915618 | 0.957661667 |
| soldier_vox10-_0690.ply | r01 | 0.354957 | 0.186589 | −0.0403 | 0.167082 |
| | r02 | 0.475145 | 0.221757 | 0.11734 | 0.271414 |
| | r03 | 0.759607 | 0.434678 | 0.316212 | 0.503499 |
| | r04 | 1.036156 | 0.56528 | 0.50495 | 0.702128667 |
| | r05 | 1.168133 | 0.747824 | 0.794697 | 0.903551333 |
| | r06 | 0.986207 | 0.92869 | 0.95403 | 0.956309 |
| Average | | 0.684409708 | 0.437127083 | 0.568412125 | 0.563316306 |

In addition, referring to FIG. 11, condition C1 is a lossless geometry and lossy attribute encoding mode. End-to-End Bjøntegaard-delta (BD)-AttrRate in the figure indicates that a BD-Rate of an end-to-end attribute value relative to an attribute bitstream. The BD-Rate reflects a difference between PSNR curves in two cases (whether the PCQEN model is adopted or not). If the BD-Rate is decreased, it indicates that the bit-rate is reduced and the performance is improved on condition that the PSNR remains constant; otherwise, the performance is degraded. That is, greater decrease in the BD-Rate corresponds to better compression effect. In Table 1, ΔY is a magnitude of increase in PSNR of a Y component of the quality-enhanced point cloud relative to the reconstructed point cloud, ΔU is a magnitude of increase in PSNR of a U component of the quality-enhanced point cloud relative to the reconstructed point cloud, and ΔV is a magnitude of increase in PSNR of a V component of the quality-enhanced point cloud relative to the reconstructed point cloud.

That is, it can be concluded from FIG. 11 that, through post-processing through the PCQEN model, the overall compression performance is greatly improved, and there is substantial BD-Rate saving. Table 1 shows in detail quality improvement of each test sequence in each component and in each bit-rate. As can be seen, the network model has good generalization performance, and can have quality improvement stably for each case, especially for a reconstructed point cloud with medium or high bit-rate (less distortion).

Exemplarily, FIG. 12A and FIG. 12B are schematic diagrams illustrating comparison between point cloud pictures before and after quality enhancement provided in embodiments of the disclosure, which are specifically schematic diagrams illustrating subjective quality comparison: comparison before and after quality enhancement of loot_vox10_1200.ply in bit-rate r03. FIG. 12A is a point cloud picture before quality enhancement, and FIG. 12B is a point cloud picture after quality enhancement (i.e. quality enhancement performed by using the PCQEN model). It can be seen from FIG. 12A and FIG. 12B that, difference before and after the quality enhancement is very significant, and the latter is clearer in texture and more natural in transition, which leads to better subjective feeling.

Embodiments of the disclosure provide a decoding method. The implementations of the embodiments are described in detail with reference to the foregoing embodiments. As can be seen, the technical solutions of the foregoing embodiments provide a technology for post-processing for quality enhancement on the reconstructed point cloud by using a neural network. The technology is implemented mainly with aid of a PCQEN model. In the network model, a graph attention module, i.e. GAPLayer, is used to pay more attention to important features; and on the other hand, the design of the network model is intended for a regressive task of point-cloud colour quality enhancement. Since such processing is intended for attribute information, geometry information of the point cloud is also needed as an auxiliary input when constructing a graph structure. In addition, in the network model, features extraction is performed though multiple times of graph convolutions or MLP operations, more attention is paid to the most important neighbor information by using the max pooling layer, and existing features are concatenated with previous features repeatedly so as to better take account of global and local features as well as features with different granularities and establish connections between different layers. Furthermore, a BatchNorm layer and an activation function LeakyReLU are added following the convolutional layer, so as to learn a residual through skip connection. On the basis of the network framework, a total of 18 network models are trained with regard to each bit-rate and each colour component, thereby effectively ensuring quality enhancement effect of the point cloud under various conditions. On the other hand, with the technical solutions, it is possible to realize an end-to-end operation. Besides, by performing patch extraction and patch fusion on the point cloud, it is possible to realize patching of the point cloud, thereby effectively reducing resource consumption. Through repeated point extraction, processing, and mean calculation, it is possible to improve effect and robustness. As such, by performing quality enhancement on the attribute information of the reconstructed point cloud based on the preset network model, it is possible to make the processed point cloud have clearer texture and more natural transition, which means that the technical solutions lead to good performance, and quality of the point cloud and visual effect can be effectively improved.

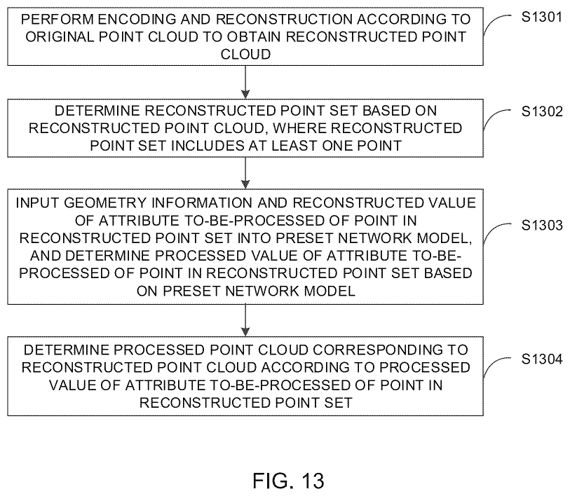

In another embodiment of the disclosure, referring to FIG. 13, FIG. 13 is a schematic flowchart of an encoding method provided in embodiments of the disclosure. As illustrated in FIG. 13, the method can include the following.

S1301, encoding and reconstruction is performed according to an original point cloud to obtain a reconstructed point cloud.

S1302, a reconstructed point set is determined based on the reconstructed point cloud, where the reconstructed point set includes at least one point.

S1303, geometry information and a reconstructed value of an attribute to-be-processed of a point in the reconstructed point set are input into a preset network model, and a processed value of the attribute to-be-processed of the point in the reconstructed point set is determined based on the preset network model.

S1304, a processed point cloud corresponding to the reconstructed point cloud is determined according to the processed value of the attribute to-be-processed of the point in the reconstructed point set.

It should be noted that, the encoding method described in embodiments of the disclosure specifically refers to a point-cloud encoding method, which can be applied to a point-cloud encoder (which can be referred to as an “encoder” for short in embodiments of the disclosure).

It should also be noted that, in embodiments of the disclosure, the encoding method is mainly applied to a technology for post-processing of attribute information of a reconstructed point cloud obtained through G-PCC encoding. Specifically, a graph-based PCQEN, that is, the preset network model, is proposed. In the preset network model, a graph structure is constructed for each point by using geometry information and a reconstructed value of an attribute to-be-processed, and then feature extraction is performed through graph convolution and graph attention mechanism. By learning a residual between the reconstructed point cloud and an original point cloud, it is possible to make the reconstructed point cloud be similar to the original point cloud as much as possible, thereby realizing quality enhancement.

It can be understood that, in embodiments of the disclosure, each point in the reconstructed point cloud has geometry information and attribute information. The geometry information represents a spatial position of the point, which can also be referred to as 3D geometry coordinate information and represented by (x, y, z). The attribute information represents an attribute value of the point, such as a colour-component value.

Here, the attribute information can include a colour component, which is specifically colour information of any colour space. Exemplarily, the attribute information can be colour information of an RGB space, or can be colour information of a YUV space, or can be colour information of a YCbCr space, and the like, and embodiments of the disclosure are not limited in this regard.

In embodiments of the disclosure, the colour component can include at least one of a first colour component, a second colour component, or a third colour component. In this case, taking a colour component as an example of the attribute information, if the colour component complies with the RGB colour space, it can be determined that the first colour component, the second colour component, and the third colour component are an R component, a G component, and a B component respectively; if the colour component complies with the YUV colour space, it can be determined that the first colour component, the second colour component, and the third colour component are a Y component, a U component, and a V component respectively; if the colour component complies with the YCbCr colour space, it can be determined that the first colour component, the second colour component, and the third colour component are a Y component, a Cb component, and a Cr component respectively.

It can also be understood that, in embodiments of the disclosure, for each point, in addition to the colour component, the attribute information of the point can also include reflectance, a refractive index, or other attributes, which is not specifically limited herein.

Further, in embodiments of the disclosure, the attribute to-be-processed refers to attribute information on which quality enhancement is currently to be performed. Taking the colour component as an example, the attribute to-be-processed can be one-dimension information, for example, the first colour component, the second colour component, or the third colour component; alternatively, the attribute to-be-processed can be two-dimension information, for example, a combination of any two of the first colour component, the second colour component, and the third colour component; alternatively, the attribute to-be-processed can even be three-dimension information including the first colour component, the second colour component, and the third colour component, which is not specifically limited herein.

That is, for each point in the reconstructed point cloud, the attribute information can include three colour components. However, when performing quality enhancement on the attribute to-be-processed by using the preset network model, only one colour component may be processed each time, that is, a single colour component and geometry information are used as inputs of the preset network model, so as to implement quality enhancement on the single colour component (the other colour components remain unchanged). Then, the same applies to the other two colour components to input the other two colour components into corresponding preset network models for quality enhancement. Alternatively, when performing quality enhancement on the attribute to-be-processed by using the preset network model, instead of processing only one colour component each time, all of the three colour components and the geometry information may be used as inputs of the preset network model. In this way, time complexity can be reduced, but quality enhancement effect will be slightly degraded.

Further, in embodiments of the disclosure, the reconstructed point cloud can be obtained by performing attribute encoding, attribute reconstruction, and geometry compensation on the original point cloud. For a point in the original point cloud, a predicted value and a residual value of attribute information of the point can be firstly determined, and then a reconstructed value of the attribute information of the point is calculated by using the predicted value and the residual value, so as to construct the reconstructed point cloud. Specifically, for a point in the original point cloud, when determining a predicted value of an attribute to-be-processed of the point, prediction can be performed on attribute information of the point according to geometry information and attribute information of multiple target neighbor points of the point in conjunction with geometry information of the point, so as to obtain a corresponding predicted value. Then addition calculation is performed according to a residual value of the attribute to-be-processed of the point and the predicted value of the attribute to-be-processed of the point, so as to obtain a reconstructed value of the attribute to-be-processed of the point. In this way, for the point in the original point cloud, after the reconstructed value of the attribute information of the point is determined, the point can be used as a nearest neighbor of a point in subsequent LOD to perform attribute prediction on the subsequent point by using the reconstructed value of the attribute information of the point, and as such, the reconstructed point cloud can be obtained.

Further, in embodiments of the disclosure, in terms of determining a residual value of an attribute to-be-processed of a point in the original point cloud, the residual value of the attribute to-be-processed of the point can be obtained by performing subtraction on an original value of the attribute to-be-processed of the point in the original point cloud and a predicted value of the attribute to-be-processed of the point. In some embodiments, the method can further include the following. A residual value of an attribute to-be-processed of a point in the original point cloud is encoded, and the encoded bits obtained are signalled into a bitstream. In this way, after the bitstream is transmitted to a decoding end, at the decoding end, the residual value of the attribute to-be-processed of the point can be obtained by parsing the bitstream, and then a reconstructed value of the attribute to-be-processed of the point can be determined by using the predicted value and the residual value, so as to construct the reconstructed point cloud.

That is, in embodiments of the disclosure, the original point cloud can be obtained directly by using a point-cloud reading function in a coding program, and the reconstructed point cloud is obtained after all encoding operations are completed. In addition, the reconstructed point cloud in embodiments of the disclosure can be a reconstructed point cloud that is output after encoding, or can be used as a reference for encoding a subsequent point cloud. Furthermore, the reconstructed point cloud herein can be in a prediction loop, that is, used as an inloop filter and used as a reference for encoding a subsequent point cloud; or can be outside the prediction loop, that is, used as a post filter and not used as a reference for encoding a subsequent point cloud, which is not specifically limited herein.

It can also be understood that, in embodiments of the disclosure, considering the number of points in the reconstructed point cloud, for example, the number of points in some large point clouds can exceed 10 million, before the reconstructed point cloud is input into the preset network model, patch extraction can be performed on the reconstructed point cloud. Here, each reconstructed point set can be regarded as one patch, and each patch extracted includes at least one point.

In some embodiments, in S1302, the reconstructed point set can be determined based on the reconstructed point cloud as follows. A key point is determined from the reconstructed point cloud. Extraction is performed on the reconstructed point cloud according to the key point to determine the reconstructed point set, where the key point and the reconstructed point set have a correspondence.

In an embodiment, the key point can be determined from the reconstructed point cloud as follows. The key point is determined by performing FPS on the reconstructed point cloud.

It should be noted that, in embodiments of the disclosure, P key points can be obtained by means of FPS, where P is an integer and P>0. Here, for each key point, patch extraction can be performed to obtain a reconstructed point set corresponding to the key point. Taking a certain key point as an example, in some embodiments, extraction can be performed on the reconstructed point cloud according to the key point to determine the reconstructed point set as follows. KNN search is performed in the reconstructed point cloud according to key point, to determine a neighbor point corresponding to the key point. The reconstructed point set is determined based on the neighbor point corresponding to the key point.

Further, with regard to KNN search, in an embodiment, KNN search can be performed in the reconstructed point cloud according to the key point to determine the neighbor point corresponding to the key point as follows. Based on the key point, search for a first preset number of candidate points in the reconstructed point cloud through KNN search. A distance between the key point and each of the first preset number of candidate points is calculated, and a second preset number of smaller distances are determined from the obtained first preset number of distances. The neighbor point corresponding to the key point is determined according to candidate points corresponding to the second preset number of distances.

In embodiments of the disclosure, the second preset number is smaller than or equal to the first preset number.

It should also be noted that, taking a certain key point as an example, the first preset number of candidate points can be found from the reconstructed point cloud through KNN search, the distance between the key point and each of the candidate points is calculated, and then the second preset number of candidate points that are closest to the key point are selected from the candidate points. The second preset number of candidate points are used as neighbor points corresponding to the key point, and the reconstructed point set corresponding to the key point is formed according to the neighbor points.

In addition, in embodiments of the disclosure, the reconstructed point set may include the key point itself, or may not include the key point itself. If the reconstructed point set includes the key point itself, in some embodiments, the reconstructed point set can be determined based on the neighbor point corresponding to the key point as follows. The reconstructed point set is determined based on the key point and the neighbor point corresponding to the key point.

It should also be noted that, the reconstructed point set can include n points, where n is an integer and n>0. Exemplarily, n can be 2048, but no limitation is imposed thereto. In embodiments of the disclosure, for the determination of the number of key points, there is an association between the number of key points, the number of points in the reconstructed point cloud, and the number of points in the reconstructed point set. Therefore, in some embodiments, the method can further include the following. The number of points in the reconstructed point cloud is determined. The number of key points is determined according to the number of points in the reconstructed point cloud and the number of points in the reconstructed point set.

In an embodiment, the number of key points can be determined according to the number of points in the reconstructed point cloud and the number of points in the reconstructed point set as follows. A first factor is determined. A product of the number of points in the reconstructed point cloud and the first factor is calculated. The number of key points is determined according to the product and the number of points in the reconstructed point set.

In embodiments of the disclosure, the first factor can be represented by γ, which is referred to as a duplication-rate factor and is used to control the average number of times that each point is fed to the preset network model. Exemplarily, γ=3, but no limitation is imposed thereto.

In a more embodiment, assuming that the number of points in the reconstructed point cloud is N, the number of points in the reconstructed point set is n, and the number of key points is P, then

$$P = round ( \frac{N \times γ}{n} ) .$$

That is, for the reconstructed point cloud, P key points can be determined by means of FPS, and then patch extraction is performed with regard to each key point, specifically, KNN search where K=n is performed for each key point, so that P patches with the size of n can be obtained, i.e. Preconstructed point sets are obtained, and each reconstructed point set includes n points.

In addition, it should also be noted that, for the points in the reconstructed point cloud, there may be duplication of points in the P reconstructed point sets. In other words, a certain point may appear in multiple reconstructed point sets, or may not appear in any of the P reconstructed point sets. This is the role of the first factor (γ), that is, to control an average duplication rate at which each point appears in the P reconstructed point sets, so as to better improve quality of the point cloud when performing patch fusion.

Further, in embodiments of the disclosure, the point cloud is usually represented by an RGB colour space, but a YUV colour space is usually adopted when performing quality enhancement on the attribute to-be-processed through the preset network model. Therefore, before inputting the geometry information and the reconstructed value of the attribute to-be-processed of the point in the reconstructed point set into the preset network model, colour space conversion needs to be performed on a colour component(s). Specifically, in some embodiments, if the colour component does not comply with the YUV colour space, colour space conversion is performed on the colour component of the point in the reconstructed point set, to make the converted colour component comply with the YUV colour space. For example, the colour components are converted into the YUV colour space from the RGB colour space, and then a colour component (for example, a Y component) which requires quality enhancement is extracted and then input into the preset network model together with geometry information.

In some embodiments, in S1303, the geometry information and the reconstructed value of the attribute to-be-processed of the point in the reconstructed point set can be input into the preset network model and the processed value of the attribute to-be-processed of the point in the reconstructed point set can be determined based on the preset network model as follows. In the preset network model, a graph structure of the point in the reconstructed point set is obtained by performing graph construction based on the reconstructed value of the attribute to-be-processed of the point in the reconstructed point set additionally with the geometry information of the point in the reconstructed point set, and the processed value of the attribute to-be-processed of the point in the reconstructed point set is determined by performing graph convolution and graph attention mechanism on the graph structure of the point in the reconstructed point set.

Here, the preset network model can be a deep learning-based neural network model. In embodiments of the disclosure, the preset network model can also be referred to as a PCQEN model. The model at least includes a graph attention mechanism module and a graph convolutional module, so as to implement graph convolution and graph attention mechanism on the graph structure of the point in the reconstructed point set.

In an embodiment, the graph attention mechanism module can include a first graph attention mechanism module and a second graph attention mechanism module, and the graph convolutional module can include a first graph convolutional module, a second graph convolutional module, a third graph convolutional module, and a fourth graph convolutional module. In addition, the preset network model can further include a first pooling module, a second pooling module, a first concatenating module, a second concatenating module, a third concatenating module, and an addition module.

A first input end of the first graph attention mechanism module is used for receiving the geometry information, and a second input end of the first graph attention mechanism module is used for receiving the reconstructed value of the attribute to-be-processed.

A first output end of the first graph attention mechanism module is connected to an input end of the first pooling module, an output end of the first pooling module is connected to an input end of the first graph convolutional module, and an output end of the first graph convolutional module is connected to a first input end of the first concatenating module.

A second output end of the first graph attention mechanism module is connected to a first input end of the second concatenating module, a second input end of the second concatenating module is used for receiving the reconstructed value of the attribute to-be-processed, and an output end of the second concatenating module is connected to an input end of the second graph convolutional module.

A first input end of the second graph attention mechanism module is used for receiving the geometry information, and a second input end of the second graph attention mechanism module is connected to an output end of the second graph convolutional module, a first output end of the second graph attention mechanism module is connected to an input end of the second pooling module, and an output end of the second pooling module is connected to a second input end of the first concatenating module.

A second output end of the second graph attention mechanism module is connected to a first input end of the third concatenating module, a second input end of the third concatenating module is connected to an output end of the second graph convolutional module, an output end of the third concatenating module is connected to an input end of the third graph convolutional module, and an output end of the third graph convolutional module is connected to a third input end of the first concatenating module, and the output end of the second graph convolutional module is also connected to a fourth input end of the first concatenating module.

An output end of the first concatenating module is connected to an input end of the fourth graph convolutional module, an output end of the fourth graph convolutional module is connected to a first input end of the addition module, a second input end of the addition module is used for receiving the reconstructed value of the attribute to-be-processed, and an output end of the addition module is used for outputting the processed value of the attribute to-be-processed.

Further, in embodiments of the disclosure, a batch normalization layer and an activation layer can be added following the convolutional layer, so as to accelerate convergence and introduce nonlinear characteristics. Therefore, in some embodiments, each of the first graph convolutional module, the second graph convolutional module, the third graph convolutional module, and the fourth graph convolutional module further includes at least one batch normalization layer and at least one activation layer, where the batch normalization layer and the activation layer are connected subsequent to the convolutional layer. However, it should be noted that, the last convolutional layer in the fourth graph convolutional module may not be followed by the batch normalization layer and activation layer.

It should be noted that, the activation layer can include an activation function, for example, a Leaky ReLU function and a Noisy ReLU function. Exemplarily, except the last layer, each of the other 1×1 convolutional layers is followed by the BatchNorm layer to accelerate convergence and prevent overfitting, and then is followed by a LeakyReLU activation function with a slope of 0.2 to introduce nonlinearity.

In an embodiment, in S1303, the geometry information and the reconstructed value of the attribute to-be-processed of the point in the reconstructed point set can be input into the preset network model and the processed value of the attribute to-be-processed of the point in the reconstructed point set can be determined based on the preset network model as follows. Through the first graph attention mechanism module, feature extraction is performed on the geometry information and the reconstructed value of the attribute to-be-processed, to obtain a first graph feature and a first attention feature. Through the first pooling module and the first graph convolutional module, feature extraction is performed on the first graph feature to obtain a second graph feature. Through the second concatenating module, the first attention feature and the reconstructed value of the attribute to-be-processed are concatenated to obtain a first concatenated attention feature. Through the second graph convolutional module, feature extraction is performed on the first concatenated attention feature to obtain a second attention feature. Through the second graph attention mechanism module, feature extraction is performed on the geometry information and the second attention feature to obtain a third graph feature and a third attention feature. Through the second pooling module, feature extraction is performed on the third graph feature to obtain a fourth graph feature. Through the third concatenating module, the third attention feature and the second attention feature are concatenated to obtain a second concatenated attention feature. Through the third graph convolutional module, feature extraction is performed on the second concatenated attention feature to obtain a fourth attention feature. Through the first concatenating module, the second graph feature, the fourth graph feature, the second attention feature, and the fourth attention feature are concatenated to obtain a target feature. Through the fourth graph convolutional module, convolution is performed on the target feature to obtain a residual value of the attribute to-be-processed of the point in the reconstructed point set. Through the addition module, addition calculation is performed on the residual value of the attribute to-be-processed of the point in the reconstructed point set and the reconstructed value of the attribute to-be-processed, to obtain the processed value of the attribute to-be-processed of the point in the reconstructed point set.

It should be noted that, in order to take full advantage of a CNN, a point cloud network (PointNet) provides an efficient approach to learn shape features directly on an unordered 3D point cloud and has achieved competitive performance. However, local feature that is helpful towards better contextual learning is not considered. Meanwhile, attention mechanism shows efficiency in capturing node representation on graph-based data through attention to neighboring nodes. Therefore, a new neural network for point cloud, namely GAPnet, can be proposed to learn local geometric representations by embedding graph attention mechanism within MLP layers. In embodiments of the disclosure, a GAPLayer module is introduced here, to learn attention features for each point by highlighting different attention weights on neighborhood. Secondly, in order to exploit sufficient features, a multi-head mechanism is employed to allow the GAPLayer module to aggregate different features from single heads. Thirdly, it is also proposed that an attention pooling layer is employed over neighbor networks to capture local signature so as to enhance network robustness. Finally, in the GAPNet, stacked MLP layers are applied to attention features and graph features to fully extract input information of the attribute to-be-processed.

That is, in embodiments of the disclosure, the first graph attention mechanism module has the same structure as the second graph attention mechanism module. The first graph attention mechanism module and the second graph attention mechanism module can each include a fourth concatenating module and a preset number of graph attention mechanism sub-modules, where the graph attention mechanism sub-module can be a single-head GAPLayer module. In this way, the graph attention mechanism module that includes the preset number of single-head GAPLayer modules is a multi-head mechanism. That is, the multi-head GAPLayer (which can be referred to as “GAPLayer module” for short) refers to the first graph attention mechanism module or the second graph attention mechanism module.

In some embodiments, the internal connection relationship within each of the first graph attention mechanism module and the second graph attention mechanism module is described as follows.

In the first graph attention mechanism module, an input end of each of the preset number of graph attention mechanism sub-modules is used for receiving the geometry information and the reconstructed value of the attribute to-be-processed, an output end of each of the preset number of graph attention mechanism sub-modules is connected to an input end of the fourth concatenating module, and an output end of the fourth concatenating module is used for outputting the first graph feature and the first attention feature.

In the second graph attention mechanism module, an input end of each of the preset number of graph attention mechanism sub-modules is used for receiving the geometry information and the second attention feature, an output end of each of the preset number of graph attention mechanism sub-modules is connected to an input end of the fourth concatenating module, and an output end of the fourth concatenating module is used for outputting the third graph feature and the third attention feature.

In embodiments of the disclosure, in order to obtain sufficient structure information and a stable network, by concatenating the outputs of four graph attention mechanism sub-modules together via a concatenating module, multi-attention features and multi-graph features can be obtained. Taking FIG. 6 as an example, if the graph attention mechanism module illustrated in FIG. 6 is the first graph attention mechanism module, the input module receives the geometry information and the reconstructed value of the attribute to-be-processed, the output multi-graph features are the first graph feature, and the output multi-attention features are the first attention feature. If the graph attention mechanism module illustrated in FIG. 6 is the second graph attention mechanism module, the input module receives the geometry information and the second attention feature, the output multi-graph features are the third graph feature, and the output multi-attention features are the third attention feature.

In some embodiments, taking the first graph attention mechanism module 501 as an example, feature extraction can be performed on the geometry information and the reconstructed value of the attribute to-be-processed through the first graph attention mechanism module to obtain the first graph feature and the first attention feature as follows. The geometry information and the reconstructed value of the attribute to-be-processed are input into the graph attention mechanism sub-module to obtain an initial graph feature and an initial attention feature. A preset number of initial graph features and a preset number of initial attention features are obtained through the preset number of graph attention mechanism sub-modules. The preset number of initial graph features are concatenated through the concatenating module to obtain the first graph feature. The preset number of initial attention features are concatenated through the concatenating module to obtain the first attention feature.

In an embodiment, the graph attention mechanism sub-module at least includes multiple MLP modules. Accordingly, the geometry information and the reconstructed value of the attribute to-be-processed can be input into the graph attention mechanism sub-module to obtain the initial graph feature and the initial attention feature as follows. A graph structure of the point in the reconstructed point set is obtained by performing graph construction based on the reconstructed value of the attribute to-be-processed additionally with the geometry information. Feature extraction is performed on the graph structure through at least one of the MLP modules to obtain the initial graph feature. Feature extraction is performed on the reconstructed value of the attribute to-be-processed through at least one of the MLP modules to obtain first intermediate feature information. Feature extraction is performed on the initial graph feature through at least one of the MLP modules to obtain second intermediate feature information. Feature aggregation is performed on the first intermediate feature information and the second intermediate feature information by using a first preset function, to obtain an attention coefficient. Normalization is performed on the attention coefficient by using a second preset function, to obtain a feature weight. The initial attention feature is obtained according to the feature weight and the initial graph feature.

It should be noted that, in embodiments of the disclosure, the first preset function is different from the second preset function. The first preset function is a nonlinear activation function, for example, a LeakyReLU function; and the second preset function is a normalized exponential function, for example, a softmax function. Here, the softmax function can “convert” a K-dimension vector z of arbitrary real numbers into another K-dimension vector σ(z), such that the range of each element is within (0, 1), and the sum of all the elements is 1. Briefly speaking, the softmax function is mainly used for normalization.

It should also be noted that, in terms of obtaining the initial attention feature according to the feature weight and the initial graph feature, linear combination operation can be performed according to the feature weight and the initial graph feature to generate the initial attention feature. Here, the initial graph feature is n×k×F′, the feature weight is n×1×k, and the initial attention feature obtained through linear combination operation is n×F′.

Specifically, in embodiments of the disclosure, with aid of the graph attention mechanism module, after constructing the graph structure, for each point, a neighborhood feature that is more important to the point is given a greater weight by means of the attention structure, so as to better perform feature extraction through graph convolution. In the first graph attention mechanism module, additional input of the geometry information is required to assist in constructing the graph structure. The first graph attention mechanism module can be formed by four graph attention mechanism sub-modules, and accordingly, the final output is obtained by concatenating outputs of all the graph attention mechanism sub-modules. In the graph attention mechanism sub-module, after constructing a graph structure with the neighborhood size of k (for example, k=20) through KNN search, graph convolution is performed on an edge feature in the graph structure to obtain the output of one of the graph attention mechanism sub-modules, i.e. the initial graph feature. On the other hand, an input feature after passing through two MLP layers and a graph feature after passing through one more MLP layer are aggregated and then pass through an activation function LeakyReLU, and a k-dimension feature weight is obtained through normalization by using a softmax function. By applying the weight to the k-neighborhood (graph feature) of the current point, the other output (the initial attention feature) can be obtained.

In this way, based on the preset network model in embodiments of the disclosure, the input of the preset network model is the geometry information and the reconstructed value of the attribute to-be-processed of the point in the reconstructed point set. By constructing a graph structure for each point in the reconstructed point set and extracting the graph feature through graph convolution and graph attention mechanism, a residual between the reconstructed point cloud and the original point cloud is learned. Finally, the output of the preset network model is the processed value of the attribute to-be-processed of the point in the reconstructed point set.

In some embodiments, in S1304, the processed point cloud corresponding to the reconstructed point cloud can be determined according to the processed value of the attribute to-be-processed of the point in the reconstructed point set as follows. A target set corresponding to the reconstructed point set is determined according to the processed value of the attribute to-be-processed of the point in the reconstructed point set. The processed point cloud is determined according to the target set.

It should be noted that, in embodiments of the disclosure, one or more patches (i.e. reconstructed point sets) can be obtained by performing patch extraction on the reconstructed point cloud. For a patch, after the attribute to-be-processed of the point in the reconstructed point set is processed through the preset network model, the processed value of the attribute to-be-processed of the point in the reconstructed point set is obtained. Then, the reconstructed value of the attribute to-be-processed of the point in the reconstructed point set is updated with the processed value of the attribute to-be-processed, and as such, the target set corresponding to the reconstructed point set can be obtained, thereby determining the processed point cloud.

Further, in some embodiments, the processed point cloud can be determined according to the target set as follows. If the key point is multiple key points, extraction is performed on the reconstructed point cloud according to the multiple key points to obtain multiple reconstructed point sets. After determining target sets corresponding to the multiple reconstructed point sets, the processed point cloud is determined by performing fusion according to the multiple target sets obtained.

In an embodiment, the processed point cloud can be determined by performing fusion according to the multiple obtained target sets as follows. If at least two of the multiple target sets include a processed value of an attribute to-be-processed of a first point, the mean value of the obtained at least two processed values is calculated to determine a processed value of the attribute to-be-processed of the first point in the processed point cloud. If none of the multiple target sets includes the processed value of the attribute to-be-processed of the first point, a reconstructed value of the attribute to-be-processed of the first point in the reconstructed point cloud is determined as the processed value of the attribute to-be-processed of the first point in the processed point cloud. The first point is any one point in the reconstructed point cloud.

It should be noted that, in embodiments of the disclosure, when constructing the reconstructed point set, some points in the reconstructed point cloud may not have been extracted, while some points in the reconstructed point cloud have been extracted repeatedly and as a result such points are repeatedly fed into the preset network model. Therefore, for a point that has not yet been extracted, the reconstructed value of the point can be reserved, while for a point that has been extracted repeatedly, the mean value thereof can be calculated as the final value. In this way, the processed point cloud with enhanced quality can be obtained after all the reconstructed point sets are fused.

It should also be noted that, in embodiments of the disclosure, the point cloud is usually represented by an RGB colour space, and if a point cloud is represented by YUV components, it is difficult to realize visualization of the point cloud by using an existing application. Therefore, after determining the processed point cloud corresponding to the reconstructed point cloud, the method can further include the following. If a colour component does not comply with an RGB colour space (for example, a YUV colour space, a YCbCr colour space, and the like), colour space conversion is performed on the colour component of a point in the processed point cloud, to make the converted colour component comply with the RGB colour space. In this way, if the colour component of the point in the processed point cloud complies with the YUV colour space, the colour component of the point in the processed point cloud needs to be converted into the RGB colour space from the YUV colour space, and then the reconstructed point cloud is updated with the processed point cloud.

Further, the preset network model is obtained by training a preset PCQEN based on deep learning. Therefore, in some embodiments, the method can further include the following. A training sample set is determined, where the training sample set includes at least one point-cloud sequence. Extraction is performed on the at least one point-cloud sequence to obtain multiple sample point sets. In a preset bit-rate, model training is performed on an initial model by using geometry information and an original value of an attribute to-be-processed of multiple sample point sets, to determine the preset network model.

It should be noted that, for the training sample set, the following sequences can be selected from the existing point-cloud sequences: Andrew.ply, boxer_viewdep_vox12.ply, David.ply, exercise_vox11_00000040.ply, longdress_vox10_1100.ply, longdress_vox10_1200.ply, longdress_vox10_1300.ply, model_vox11_00000035.ply, Phil.ply, queen 0050.ply, queen_0150.ply, redandblack_vox10_1450.ply, redandblack_vox10_1500.ply, Ricardo.ply, Sarah.ply, thaidancer_viewdep_vox12.ply. Then, a patch(es) (i.e. sample point set) is extracted from each of the above point-cloud sequences, and the number of patches extracted from each point-cloud sequence is:

$$round ( \frac{N \times 3}{2048} ) ,$$

where N is the number of points in the point-cloud sequence. When performing model training, the total number of patches can be 34848, and these patches are fed into the initial model for training, so as to obtain the preset network model.

It should also be noted that, in embodiments of the disclosure, the initial model is related to a bit-rate, different bit-rates can correspond to different initial models, and different colour components can also correspond to different initial models. In this way, with regard to six bit-rates r01˜r06 and three colour components Y/U/V in each bit-rate, there are totally 18 initial models to be trained, and thus 18 preset network models can be obtained. That is, different bit-rates or different colour components correspond to different preset network models.

After the preset network model is obtained through training, network test can be performed by using a testing point-cloud sequence. The testing point-cloud sequence can be: basketball_player_vox11_00000200.ply, dancer_vox11_00000001.ply, loot_vox10_1200.ply, soldier_vox10_0690.ply. In the test, the input is the whole point-cloud sequence. In each bit-rate, patch extraction is performed on each point-cloud sequence, then the patch(es) is input to the trained preset network model to perform quality enhancement on each of Y/U/V colour components. Finally, the processed patches are fused to generate a point cloud with enhanced quality. That is, embodiments of the disclosure propose a technology for post-processing of a colour attribute of a reconstructed point cloud obtained through G-PCC decoding, in which model training is performed on a preset PCQEN based on deep learning, and the performance of the network model is tested by using a testing set.

Further, in embodiments of the disclosure, for the preset network model, instead of inputting a single colour component and geometry information, all the three colour components Y/U/V and geometry information can be used as inputs of the preset network model instead of processing only one colour component each time. In this way, time complexity can be reduced, but the effect will be slightly degraded.

Further, in embodiments of the disclosure, the application scope of the encoding method can also be extended, and can be used for post-processing after coding of a multi-frame/dynamic point cloud in addition to processing a single-frame point cloud. Exemplarily, in InterEM V5.0 of the G-PCC framework, there is an inter-prediction operation on attribute information, and therefore, the quality of the next frame depends greatly on the current frame. Thus, in embodiments of the disclosure, with aid of the preset network model, a reflectance attribute of a reconstructed point cloud, which is obtained through decoding of each frame of point cloud in a multi-frame point cloud, can be post-processed, and the reconstructed point cloud can be replaced with a processed point cloud with enhanced quality in order for inter prediction, which is possible to significantly improve attribute reconstruction quality of the next frame of point cloud.

Embodiments of the disclosure provide an encoding method. Encoding and reconstruction is performed according to the original point cloud to obtain the reconstructed point cloud. The reconstructed point set is determined based on the reconstructed point cloud, where the reconstructed point set includes at least one point. The geometry information and the reconstructed value of the attribute to-be-processed of the point in the reconstructed point set are input into the preset network model, and the processed value of the attribute to-be-processed of the point in the reconstructed point set is determined based on the preset network model. The processed point cloud corresponding to the reconstructed point cloud is determined according to the processed value of the attribute to-be-processed of the point in the reconstructed point set. In this way, by performing quality enhancement on attribute information of the reconstructed point cloud based on the preset network model, it is possible not only to perform training on different network models with regard to various bit-rates and various colour components based on the network framework so as to effectively ensure quality enhancement effect of the point cloud under various conditions, but also to realize an end-to-end operation. On the other hand, by performing patch extraction and patch fusion on the reconstructed point cloud, it is possible to realize patching of the point cloud, thereby effectively reducing resource consumption. Through repeated point extraction, processing, and mean calculation, it is possible to improve effect and robustness of the network model. In addition, by performing quality enhancement on the attribute information of the reconstructed point cloud based on the preset network model, it is possible to make the processed point cloud have clearer texture and more natural transition, which can effectively improve quality of the point cloud and visual effect, thereby improving compression performance of the point cloud.

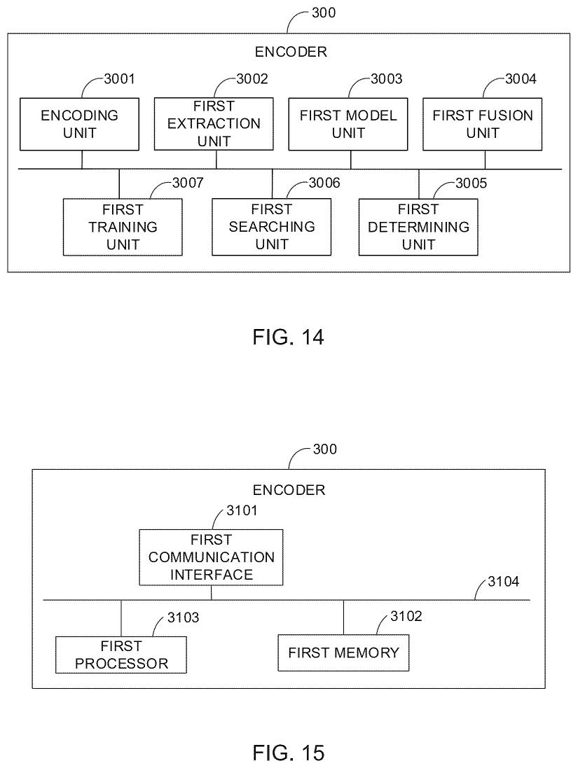

In another embodiment of the disclosure, based on the same inventive concept as the foregoing embodiments, referring to FIG. 14, FIG. 14 is a schematic structural diagram of an encoder 300 provided in embodiments of the disclosure. As illustrated in FIG. 14, the encoder 300 can include: an encoding unit 3001, a first extraction unit 3002, a first model unit 3003, and a first fusion unit 3004. The encoding unit 3001 is configured to perform encoding and reconstruction according to an original point cloud to obtain a reconstructed point cloud. The first extraction unit 3002 is configured to determine a reconstructed point set based on the reconstructed point cloud, where the reconstructed point set includes at least one point. The first model unit 3003 is configured to input geometry information and a reconstructed value of an attribute to-be-processed of a point in the reconstructed point set into a preset network model, and determine a processed value of the attribute to-be-processed of the point in the reconstructed point set based on the preset network model. The first fusion unit 3004 is configured to determine a processed point cloud corresponding to the reconstructed point cloud according to the processed value of the attribute to-be-processed of the point in the reconstructed point set.

In some embodiments, referring to FIG. 14, the encoder 300 can further comprise a first determining unit 3005. The first determining unit 3005 is configured to determine a key point from the reconstructed point cloud. The first extraction unit 3002 is configured to perform extraction on the reconstructed point cloud according to the key point to determine the reconstructed point set, where the key point and the reconstructed point set have a correspondence.

In some embodiments, the first determining unit 3005 is further configured to determine the key point by performing FPS on the reconstructed point cloud.

In some embodiments, referring to FIG. 14, the encoder 300 can further include a first searching unit 3006. The first searching unit 3006 is configured to perform KNN search in the reconstructed point cloud according to the key point, to determine a neighbor point corresponding to the key point. The first determining unit 3005 is further configured to determine the reconstructed point set based on the neighbor point corresponding to the key point.

In some embodiments, the first searching unit 3006 is configured to: based on the key point, search for a first preset number of candidate points in the reconstructed point cloud through KNN search; calculate a distance between the key point and each of the first preset number of candidate points, and determine a second preset number of smaller distances from the obtained first preset number of distances; and determine the neighbor point corresponding to the key point according to candidate points corresponding to the second preset number of distances, where the second preset number is smaller than or equal to the first preset number.

In some embodiments, the first determining unit 3005 is further configured to determine the reconstructed point set according to the key point and the neighbor point corresponding to the key point.

In some embodiments, the first determining unit 3005 is further configured to determine the number of points in the reconstructed point cloud, and determine the number of key points according to the number of points in the reconstructed point cloud and the number of points in the reconstructed point set.

In some embodiments, the first determining unit 3005 is further configured to: determine a first factor, calculate a product of the number of points in the reconstructed point cloud and the first factor, and determine the number of key points according to the product and the number of points in the reconstructed point set.

In some embodiments, the first determining unit 3005 is further configured to determine a target set corresponding to the reconstructed point set according to the processed value of the attribute to-be-processed of the point in the reconstructed point set, and determine the processed point cloud according to the target set.

In some embodiments, the first extraction unit 3002 is configured to, if the key point is multiple key points, perform extraction on the reconstructed point cloud according to the multiple key points to obtain multiple reconstructed point sets. The first fusion unit 3004 is configured to, after determining target sets corresponding to the multiple reconstructed point sets, determine the processed point cloud by performing fusion according to the multiple target sets obtained.

In some embodiments, the first fusion unit 3004 is further configured to: if at least two of the multiple target sets include a processed value of an attribute to-be-processed of a first point, calculate the mean value of the obtained at least two processed values to determine a processed value of the attribute to-be-processed of the first point in the processed point cloud; if none of the multiple target sets includes the processed value of the attribute to-be-processed of the first point, determine a reconstructed value of the attribute to-be-processed of the first point in the reconstructed point cloud as the processed value of the attribute to-be-processed of the first point in the processed point cloud, where the first point is any one point in the reconstructed point cloud.

In some embodiments, the first model unit 3003 is configured to: in the preset network model, obtain a graph structure of the point in the reconstructed point set by performing graph construction based on the reconstructed value of the attribute to-be-processed of the point in the reconstructed point set additionally with the geometry information of the point in the reconstructed point set, and determine the processed value of the attribute to-be-processed of the point in the reconstructed point set by performing graph convolution and graph attention mechanism on the graph structure of the point in the reconstructed point set.

In some embodiments, the preset network model is a deep learning-based neural network model, and the preset network model at least includes a graph attention mechanism module and a graph convolutional module.

In some embodiments, the graph attention mechanism module includes a first graph attention mechanism module and a second graph attention mechanism module, and the graph convolutional module includes a first graph convolutional module, a second graph convolutional module, a third graph convolutional module, and a fourth graph convolutional module. The preset network model further includes a first pooling module, a second pooling module, a first concatenating module, a second concatenating module, a third concatenating module, and an addition module.

A first input end of the first graph attention mechanism module is used for receiving the geometry information, and a second input end of the first graph attention mechanism module is used for receiving the reconstructed value of the attribute to-be-processed.

A first output end of the first graph attention mechanism module is connected to an input end of the first pooling module, an output end of the first pooling module is connected to an input end of the first graph convolutional module, and an output end of the first graph convolutional module is connected to a first input end of the first concatenating module.

A second output end of the first graph attention mechanism module is connected to a first input end of the second concatenating module, a second input end of the second concatenating module is used for receiving the reconstructed value of the attribute to-be-processed, and an output end of the second concatenating module is connected to an input end of the second graph convolutional module.

A first input end of the second graph attention mechanism module is used for receiving the geometry information, and a second input end of the second graph attention mechanism module is connected to an output end of the second graph convolutional module, a first output end of the second graph attention mechanism module is connected to an input end of the second pooling module, and an output end of the second pooling module is connected to a second input end of the first concatenating module.

A second output end of the second graph attention mechanism module is connected to a first input end of the third concatenating module, a second input end of the third concatenating module is connected to an output end of the second graph convolutional module, an output end of the third concatenating module is connected to an input end of the third graph convolutional module, and an output end of the third graph convolutional module is connected to a third input end of the first concatenating module, and the output end of the second graph convolutional module is also connected to a fourth input end of the first concatenating module.

An output end of the first concatenating module is connected to an input end of the fourth graph convolutional module, an output end of the fourth graph convolutional module is connected to a first input end of the addition module, a second input end of the addition module is used for receiving the reconstructed value of the attribute to-be-processed, and an output end of the addition module is used for outputting the processed value of the attribute to-be-processed.

In some embodiments, the first model unit 3003 is configured to: perform, through the first graph attention mechanism module, feature extraction on the geometry information and the reconstructed value of the attribute to-be-processed, to obtain a first graph feature and a first attention feature; perform, through the first pooling module and the first graph convolutional module, feature extraction on the first graph feature to obtain a second graph feature; concatenate, through the second concatenating module, the first attention feature and the reconstructed value of the attribute to-be-processed to obtain a first concatenated attention feature; perform, through the second graph convolutional module, feature extraction on the first concatenated attention feature to obtain a second attention feature; perform, through the second graph attention mechanism module, feature extraction on the geometry information and the second attention feature to obtain a third graph feature and a third attention feature; perform, through the second pooling module, feature extraction on the third graph feature to obtain a fourth graph feature; concatenate, through the third concatenating module, the third attention feature and the second attention feature to obtain a second concatenated attention feature; perform, through the third graph convolutional module, feature extraction on the second concatenated attention feature to obtain a fourth attention feature; concatenate, through the first concatenating module, the second graph feature, the fourth graph feature, the second attention feature, and the fourth attention feature to obtain a target feature; perform, through the fourth graph convolutional module, convolution on the target feature to obtain a residual value of the attribute to-be-processed of the point in the reconstructed point set; and perform, through the addition module, addition calculation on the residual value of the attribute to-be-processed of the point in the reconstructed point set and the reconstructed value of the attribute to-be-processed, to obtain the processed value of the attribute to-be-processed of the point in the reconstructed point set.

In some embodiments, each of the first graph convolutional module, the second graph convolutional module, the third graph convolutional module, and the fourth graph convolutional module includes at least one convolutional layer.

In some embodiments, each of the first graph convolutional module, the second graph convolutional module, the third graph convolutional module, and the fourth graph convolutional module further includes at least one batch normalization layer and at least one activation layer, where the batch normalization layer and the activation layer are connected following the convolutional layer.

In some embodiments, a last convolutional layer in the fourth graph convolutional module is not followed by the batch normalization layer and the activation layer.

In some embodiments, each of the first graph attention mechanism module and the second graph attention mechanism module includes a fourth concatenating module and a preset number of graph attention mechanism sub-modules.

In the first graph attention mechanism module, an input end of each of the preset number of graph attention mechanism sub-modules is used for receiving the geometry information and the reconstructed value of the attribute to-be-processed, an output end of each of the preset number of graph attention mechanism sub-modules is connected to an input end of the fourth concatenating module, and an output end of the fourth concatenating module is used for outputting the first graph feature and the first attention feature.

In the second graph attention mechanism module, an input end of each of the preset number of graph attention mechanism sub-modules is used for receiving the geometry information and the second attention feature, an output end of each of the preset number of graph attention mechanism sub-modules is connected to an input end of the fourth concatenating module, and an output end of the fourth concatenating module is used for outputting the third graph feature and the third attention feature.

In some embodiments, the graph attention mechanism sub-module is a single-head GAPLayer module.

In some embodiments, the first model unit 3003 is further configured to: input the geometry information and the reconstructed value of the attribute to-be-processed into the graph attention mechanism sub-module to obtain an initial graph feature and an initial attention feature; obtain, through the preset number of graph attention mechanism sub-modules, a preset number of initial graph features and a preset number of initial attention features; concatenate, through the fourth concatenating module, the preset number of initial graph features to obtain the first graph feature; and concatenate, through the fourth concatenating module, the preset number of initial attention features to obtain the first attention feature.

In some embodiments, the graph attention mechanism sub-module at least includes multiple MLP modules. Accordingly, the first model unit 3003 is further configured to: obtain a graph structure of the point in the reconstructed point set by performing graph construction based on the reconstructed value of the attribute to-be-processed additionally with the geometry information; perform, through at least one of the MLP modules, feature extraction on the graph structure to obtain the initial graph feature; perform, through at least one of the MLP modules, feature extraction on the reconstructed value of the attribute to-be-processed to obtain first intermediate feature information; perform, through at least one of the MLP modules, feature extraction on the initial graph feature to obtain second intermediate feature information; perform feature aggregation on the first intermediate feature information and the second intermediate feature information by using a first preset function, to obtain an attention coefficient; perform normalization on the attention coefficient by using a second preset function, to obtain a feature weight; and obtain the initial attention feature according to the feature weight and the initial graph feature.

In some embodiments, referring to FIG. 14, the encoder 300 can further include a first training unit 3007. The first training unit 3007 is configured to: determine a training sample set, where the training sample set includes at least one point-cloud sequence; perform extraction on the at least one point-cloud sequence to obtain multiple sample point sets; and in a preset bit-rate, perform model training on an initial model by using geometry information and an original value of an attribute to-be-processed of the multiple sample point sets, to determine the preset network model.

In some embodiments, the attribute to-be-processed includes a colour component, and the colour component includes at least one of a first colour component, a second colour component, or a third colour component. Accordingly, the first determining unit 3005 is further configured to: after determining the processed point cloud corresponding to the reconstructed point cloud, if the colour component does not comply with an RGB colour space, perform colour space conversion on a colour component of a point in the processed point cloud to make the converted colour component comply with the RGB colour space.

It can be understood that, in embodiments of the disclosure, the “unit” may be part of a circuit, part of a processor, part of a program or software, etc., and of course may also be a module, or may be non-modular. In addition, various components described in embodiments of the disclosure may be integrated into one processing unit or may be present as a number of physically separated units, and two or more units may be integrated into one. The integrated unit may take the form of hardware or a software functional unit.

If the integrated units are implemented as software functional units and sold or used as standalone products, they may be stored in a computer-readable storage medium. Based on such an understanding, the essential technical solution, or the portion that contributes to the prior art, or all or part of the technical solution of the disclosure may be embodied as software products. The computer software products may be stored in a storage medium and may include multiple instructions that, when executed, may cause a computing device, e.g., a personal computer, a server, a network device, etc., or a processor to execute some or all operations of the methods described in various embodiments. The above storage medium may include various kinds of media that may store program codes, such as a universal serial bus (USB) flash disk, a mobile hard drive, a read only memory (ROM), a random access memory (RAM), a magnetic disk, or an optical disk.

Therefore, a computer storage medium applied to the encoder 300 is provided in embodiments of the disclosure. The computer storage medium stores computer programs. The computer programs, when executed by a first processor, are operable to implement the method of any one of the foregoing embodiments.

Based on the components of the encoder 300 and the computer storage medium, referring to FIG. 15, FIG. 15 is a schematic structural diagram illustrating hardware of the encoder 300 provided in embodiments of the disclosure. As illustrated in FIG. 15, the encoder 300 can include: a first communication interface 3101, a first memory 3102, and a first processor 3103. These components are coupled together via a first bus system 3104. It should be understood that, the first bus system 3104 is configured for connection and communication between these components, and the first bus system 3104 further includes a power bus, a control bus, and a state signal bus in addition to a data bus. However, for the convenience of illustration, the various buses are labeled as the first bus system 3104 in FIG. 15.

The first communication interface 3101 is configured to receive and send signals in the process of sending and receiving information with other external network elements. The first memory 3102 is configured to store computer programs executable by the first processor 3103. The first processor 3103 is configured to perform the following steps when running the computer programs: performing encoding and reconstruction according to an original point cloud to obtain a reconstructed point cloud; determining a reconstructed point set based on the reconstructed point cloud, where the reconstructed point set includes at least one point; inputting geometry information and a reconstructed value of an attribute to-be-processed of a point in the reconstructed point set into a preset network model, and determining a processed value of the attribute to-be-processed of the point in the reconstructed point set based on the preset network model; and determining a processed point cloud corresponding to the reconstructed point cloud according to the processed value of the attribute to-be-processed of the point in the reconstructed point set.

It can be understood that the first memory 3102 in embodiments of the disclosure can be a volatile memory or a non-volatile memory, or may include both the volatile memory and the non-volatile memory. The non-volatile memory may be a ROM, a programmable ROM (PROM), an erasable PROM (EPROM), an electrically EPROM (EEPROM), or flash memory. The volatile memory can be a random access memory (RAM) that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It is noted that, the first memory 3102 of the systems and methods described in the disclosure is intended to include, but is not limited to, these and any other suitable types of memory.

The first processor 3103 can be an integrated circuit chip with signal processing capabilities. During implementation, each step of the foregoing method may be completed by an integrated logic circuit in the form of hardware or an instruction in the form of software in the first processor 3103. The first processor 3103 may be a general-purpose processor, a digital signal processor (DSP), an application specific integrated circuit (ASIC), a field programmable gate array (FPGA), or other programmable logic devices, discrete gates or transistor logic devices, discrete hardware components, etc. The first processor 3103 may implement or execute the methods, operations, and logic blocks disclosed in embodiments of the disclosure. The general-purpose processor may be a microprocessor, or may be any conventional processor or the like. The operations of the method disclosed in embodiments of the disclosure may be implemented through a hardware decoding processor, or may be performed by hardware and software modules in the decoding processor. The software module may be located in a storage medium such as a RAM, a flash memory, a ROM, a PROM, or an electrically erasable programmable memory, registers, and the like. The storage medium is located in the first memory 3102. The first processor 3103 reads the information in the first memory 3102, and completes the operations of the method described above with the hardware of the first processor 3103.

It will be appreciated that embodiments described herein may be implemented in one or more of hardware, software, firmware, middleware, and microcode. For hardware implementation, the processing unit may be implemented in one or more ASICs, DSPs, DSP devices (DSPD), programmable logic devices (PLD), FPGAs, general-purpose processors, controllers, microcontrollers, microprocessors, other electronic units for performing the functions described herein or a combination thereof. For software implementation, the technology described herein may be implemented by modules (e.g., procedures, functions, and so on) for performing the functions described herein. The software code may be stored in the memory and executed by the processor. The memory may be implemented in the processor or external to the processor.

Optionally, as another embodiment, the first processor 3103 is further configured to perform the method according to any one of the foregoing embodiments when running the computer programs.

An encoder is provided in embodiments of the disclosure. The encoder includes an encoding unit, a first extraction unit, a first model unit, and a first fusion unit. The encoding unit is configured to perform encoding and reconstruction according to an original point cloud to obtain a reconstructed point cloud. The first extraction unit is configured to determine a reconstructed point set based on the reconstructed point cloud, where the reconstructed point set includes at least one point. The first model unit is configured to input geometry information and a reconstructed value of an attribute to-be-processed of a point in the reconstructed point set into a preset network model, and determine a processed value of the attribute to-be-processed of the point in the reconstructed point set based on the preset network model. The first fusion unit is configured to determine a processed point cloud corresponding to the reconstructed point cloud according to the processed value of the attribute to-be-processed of the point in the reconstructed point set.

An encoder is provided in embodiments of the disclosure. The encoder includes a first memory and a first processor. The first memory is configured to store computer programs executable by the first processor. The first processor is configured to perform the method in the second aspect when executing the computer programs.

A decoder is provided in embodiments of the disclosure. The decoder includes a second extraction unit, a second model unit, and a second fusion unit. The second extraction unit is configured to determine a reconstructed point set based on a reconstructed point cloud, where the reconstructed point set includes at least one point. The second model unit is configured to input geometry information and a reconstructed value of an attribute to-be-processed of a point in the reconstructed point set into a preset network model, and determine a processed value of the attribute to-be-processed of the point in the reconstructed point set based on the preset network model. The second fusion unit is configured to determine a processed point cloud corresponding to the reconstructed point cloud according to the processed value of the attribute to-be-processed of the point in the reconstructed point set.

A decoder is provided in embodiments of the disclosure. The decoder includes a second memory and a second processor. The second memory is configured to store computer programs executable by the second processor. The second processor is configured to perform the method in the first aspect when executing the computer programs.

A computer-readable storage medium is provided in embodiments of the disclosure. The computer-readable storage medium is configured to store computer programs which, when executed, are operable to perform the method in the first aspect or the method in the second aspect.

Embodiments of the disclosure provide a coding method, an encoder, a decoder, and a readable storage medium. At an encoding end or a decoding end, the reconstructed point set is determined based on the reconstructed point cloud, where the reconstructed point set includes at least one point. The geometry information and the reconstructed value of the attribute to-be-processed of the point in the reconstructed point set are input into the preset network model, and the processed value of the attribute to-be-processed of the point in the reconstructed point set is determined based on the preset network model. The processed point cloud corresponding to the reconstructed point cloud is determined according to the processed value of the attribute to-be-processed of the point in the reconstructed point set. In this way, by performing quality enhancement on attribute information of the reconstructed point cloud based on the preset network model, not only end-to-end operation is achieved, but also patching of the reconstructed point cloud is realized by determining the reconstructed point set from the reconstructed point cloud, thereby effectively reducing resource consumption and improving robustness of the model. In addition, when performing quality enhancement on the attribute information of the reconstructed point cloud based on the preset network model by using the geometry information as an auxiliary input of the preset network model, it is possible to make the processed point cloud have clearer texture and more natural transition, which can effectively improve quality of the point cloud and visual effect, thereby improving compression performance of the point cloud.

Embodiments provide an encoder. With aid of the encoder, after obtaining the reconstructed point cloud, by performing quality enhancement on attribute information of the reconstructed point cloud based on the preset network model, it is possible not only to realize end-to-end operation, but also realize patching of the reconstructed point cloud by performing patch extraction and patch fusion on the point cloud, thereby effectively reducing resource consumption and improving robustness of the model. As such, after performing quality enhancement on the attribute information of the reconstructed point cloud with the preset network model, it is possible to make the processed point cloud have clearer texture and more natural transition, which can effectively improve quality of the point cloud and visual effect, which means that the technical solutions leads to good performance, and quality of the point cloud and visual effect can be effectively improved.

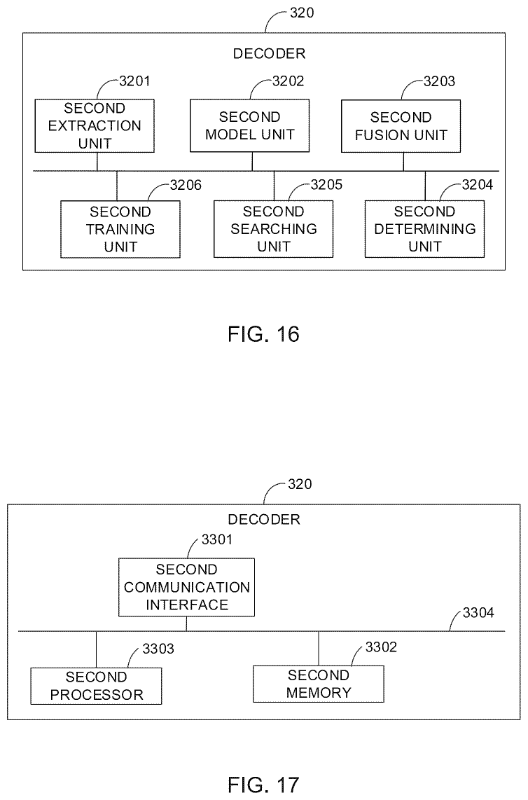

Based on the same inventive concept as the foregoing embodiments, referring to FIG. 16, FIG. 16 is a schematic structural diagram of a decoder 320 provided in embodiments of the disclosure. As illustrated in FIG. 16, the decoder 320 can include: a second extraction unit 3201, a second model unit 3202, and a second fusion unit 3203. The second extraction unit 3201 is configured to determine a reconstructed point set based on a reconstructed point cloud, where the reconstructed point set includes at least one point. The second model unit 3202 is configured to input geometry information and a reconstructed value of an attribute to-be-processed of a point in the reconstructed point set into a preset network model, and determine a processed value of the attribute to-be-processed of the point in the reconstructed point set based on the preset network model. The second fusion unit 3203 is configured to determine a processed point cloud corresponding to the reconstructed point cloud according to the processed value of the attribute to-be-processed of the point in the reconstructed point set.

In some embodiments, referring to FIG. 16, the decoder 320 can further include a second determining unit 3204. The second determining unit 3204 is configured to determine a key point from the reconstructed point cloud. The second extraction unit 3201 is configured to perform extraction on the reconstructed point cloud according to the key point to determine the reconstructed point set, where the key point and the reconstructed point set have a correspondence.

In some embodiments, the second determining unit 3204 is further configured to determine the key point by performing FPS on the reconstructed point cloud.

In some embodiments, referring to FIG. 16, the decoder 320 can further include a second searching unit 3205. The second searching unit 3205 is configured to: perform KNN search in the reconstructed point cloud according to the key point, to determine the neighbor point corresponding to the key point. The first determining unit 3005 is further configured to determine the reconstructed point set based on the neighbor point corresponding to the key point.

In some embodiments, the second searching unit 3205 is configured to: based on the key point, search for a first preset number of candidate points in the reconstructed point cloud through KNN search; calculate a distance between the key point and each of the first preset number of candidate points, and determine a second preset number of smaller distances from the obtained first preset number of distances; and determine the neighbor point corresponding to the key point according to candidate points corresponding to the second preset number of distances, where the second preset number is smaller than or equal to the first preset number.

In some embodiments, the second determining unit 3204 is further configured to determine the reconstructed point set according to the key point and the neighbor point corresponding to the key point.

In some embodiments, the second determining unit 3204 is further configured to: determine the number of points in the reconstructed point cloud; and determine the number of key points according to the number of points in the reconstructed point cloud and the number of points in the reconstructed point set.

In some embodiments, the second determining unit 3204 is further configured to determine a first factor; calculate a product of the number of points in the reconstructed point cloud and the first factor; and determine the number of key points according to the product and the number of points in the reconstructed point set.

In some embodiments, the second determining unit 3204 is further configured to determine a target set corresponding to the reconstructed point set according to the processed value of the attribute to-be-processed of the point in the reconstructed point set; and determine the processed point cloud according to the target set.

In some embodiments, the second extraction unit 3201 is configured to: if the key point is multiple key points, perform extraction on the reconstructed point cloud according to the multiple key points to obtain multiple reconstructed point sets. The second fusion unit 3203 configured to: after determining target sets corresponding to the multiple reconstructed point sets, determine the processed point cloud by performing fusion according to the multiple target sets obtained.

In some embodiments, the second grouping unit 3203 is further configured to: if at least two of the multiple target sets include a processed value of an attribute to-be-processed of a first point, calculate the mean value of the obtained at least two processed values to determine a processed value of the attribute to-be-processed of the first point in the processed point cloud; if none of the multiple target sets comprises the processed value of the attribute to-be-processed of the first point, determine a reconstructed value of the attribute to-be-processed of the first point in the reconstructed point cloud as the processed value of the attribute to-be-processed of the first point in the processed point cloud, where the first point is any one point in the reconstructed point cloud.

In some embodiments, the second model unit 3202 is configured to: in the preset network model, obtain a graph structure of the point in the reconstructed point set by performing graph construction based on the reconstructed value of the attribute to-be-processed of the point in the reconstructed point set additionally with the geometry information of the point in the reconstructed point set, and determine the processed value of the attribute to-be-processed of the point in the reconstructed point set by performing graph convolution and graph attention mechanism on the graph structure of the point in the reconstructed point set.

In some embodiments, the preset network model is a deep learning-based neural network model, and the preset network model at least includes a graph attention mechanism module and a graph convolutional module.

In some embodiments, the graph attention mechanism module includes a first graph attention mechanism module and a second graph attention mechanism module, and the graph convolutional module includes a first graph convolutional module, a second graph convolutional module, a third graph convolutional module, and a fourth graph convolutional module. The preset network model further includes a first pooling module, a second pooling module, a first concatenating module, a second concatenating module, a third concatenating module, and an addition module.

A first input end of the first graph attention mechanism module is used for receiving the geometry information, and a second input end of the first graph attention mechanism module is used for receiving the reconstructed value of the attribute to-be-processed.

A first output end of the first graph attention mechanism module is connected to an input end of the first pooling module, an output end of the first pooling module is connected to an input end of the first graph convolutional module, and an output end of the first graph convolutional module is connected to a first input end of the first concatenating module.

A second output end of the first graph attention mechanism module is connected to a first input end of the second concatenating module, a second input end of the second concatenating module is used for receiving the reconstructed value of the attribute to-be-processed, and an output end of the second concatenating module is connected to an input end of the second graph convolutional module.

A first input end of the second graph attention mechanism module is used for receiving the geometry information, and a second input end of the second graph attention mechanism module is connected to an output end of the second graph convolutional module, a first output end of the second graph attention mechanism module is connected to an input end of the second pooling module, and an output end of the second pooling module is connected to a second input end of the first concatenating module.

A second output end of the second graph attention mechanism module is connected to a first input end of the third concatenating module, a second input end of the third concatenating module is connected to an output end of the second graph convolutional module, an output end of the third concatenating module is connected to an input end of the third graph convolutional module, and an output end of the third graph convolutional module is connected to a third input end of the first concatenating module, and the output end of the second graph convolutional module is also connected to a fourth input end of the first concatenating module.

An output end of the first concatenating module is connected to an input end of the fourth graph convolutional module, an output end of the fourth graph convolutional module is connected to a first input end of the addition module, a second input end of the addition module is used for receiving the reconstructed value of the attribute to-be-processed, and an output end of the addition module is used for outputting the processed value of the attribute to-be-processed.

In some embodiments, the second model unit 3202 is configured to: perform, through the first graph attention mechanism module, feature extraction on the geometry information and the reconstructed value of the attribute to-be-processed, to obtain a first graph feature and a first attention feature; perform, through the first pooling module and the first graph convolutional module, feature extraction on the first graph feature to obtain a second graph feature; concatenate, through the second concatenating module, the first attention feature and the reconstructed value of the attribute to-be-processed to obtain a first concatenated attention feature; perform, through the second graph convolutional module, feature extraction on the first concatenated attention feature to obtain a second attention feature; perform, through the second graph attention mechanism module, feature extraction on the geometry information and the second attention feature to obtain a third graph feature and a third attention feature; perform, through the second pooling module, feature extraction on the third graph feature to obtain a fourth graph feature; concatenate, through the third concatenating module, the third attention feature and the second attention feature to obtain a second concatenated attention feature; perform, through the third graph convolutional module, feature extraction on the second concatenated attention feature to obtain a fourth attention feature; concatenate, through the first concatenating module, the second graph feature, the fourth graph feature, the second attention feature, and the fourth attention feature to obtain a target feature; perform, through the fourth graph convolutional module, convolution on the target feature to obtain a residual value of the attribute to-be-processed of the point in the reconstructed point set; and perform, through the addition module, addition on the residual value of the attribute to-be-processed of the point in the reconstructed point set and the reconstructed value of the attribute to-be-processed, to obtain the processed value of the attribute to-be-processed of the point in the reconstructed point set.

In some embodiments, each of the first graph convolutional module, the second graph convolutional module, the third graph convolutional module, and the fourth graph convolutional module includes at least one convolutional layer.

In some embodiments, each of the first graph convolutional module, the second graph convolutional module, the third graph convolutional module, and the fourth graph convolutional module further includes at least one batch normalization layer and at least one activation layer, where the batch normalization layer and the activation layer are connected following the convolutional layer.

In some embodiments, a last convolutional layer in the fourth graph convolutional module is not followed by the batch normalization layer and the activation layer.

In some embodiments, each of the first graph attention mechanism module and the second graph attention mechanism module includes a fourth concatenating module and a preset number of graph attention mechanism sub-modules.

In the first graph attention mechanism module, an input end of each of the preset number of graph attention mechanism sub-modules is used for receiving the geometry information and the reconstructed value of the attribute to-be-processed, an output end of each of the preset number of graph attention mechanism sub-modules is connected to an input end of the fourth concatenating module, and an output end of the fourth concatenating module is used for outputting the first graph feature and the first attention feature.

In the second graph attention mechanism module, an input end of each of the preset number of graph attention mechanism sub-modules is used for receiving the geometry information and the second attention feature, an output end of each of the preset number of graph attention mechanism sub-modules is connected to an input end of the fourth concatenating module, and an output end of the fourth concatenating module is used for outputting the third graph feature and the third attention feature.

In some embodiments, the graph attention mechanism sub-module is a single-head GAPLayer module.

In some embodiments, the second model unit 3202 is further configured to: input the geometry information and the reconstructed value of the attribute to-be-processed into the graph attention mechanism sub-module to obtain an initial graph feature and an initial attention feature; obtain, through the preset number of graph attention mechanism sub-modules, a preset number of initial graph features and a preset number of initial attention features; concatenate, through the fourth concatenating module, the preset number of initial graph features to obtain the first graph feature; and concatenate, through the fourth concatenating module, the preset number of initial attention features to obtain the first attention feature.

In some embodiments, the graph attention mechanism sub-module at least includes multiple MLP modules. Accordingly, a second model unit 3202 is further configured to: obtain a graph structure of the point in the reconstructed point set by performing graph construction based on the reconstructed value of the attribute to-be-processed additionally with the geometry information; perform, through at least one of the MLP modules, feature extraction on the graph structure to obtain the initial graph feature; perform, through at least one of the MLP modules, feature extraction on the reconstructed value of the attribute to-be-processed to obtain first intermediate feature information; perform, through at least one of the MLP modules, feature extraction on the initial graph feature to obtain second intermediate feature information; perform feature aggregation on the first intermediate feature information and the second intermediate feature information by using a first preset function, to obtain an attention coefficient; perform normalization on the attention coefficient by using a second preset function, to obtain a feature weight; and obtain the initial attention feature according to the feature weight and the initial graph feature.

In some embodiments, referring to FIG. 16, the decoder 320 can further include a second training unit 3206. The second training unit 3206 is configured to: determine a training sample set, where the training sample set includes at least one point-cloud sequence; perform extraction on the at least one point-cloud sequence to obtain multiple sample point sets; and in a preset bit-rate, perform model training on an initial model by using geometry information and an original value of an attribute to-be-processed of the multiple sample point sets, to determine the preset network model.

In some embodiments, the attribute to-be-processed includes a colour component, and the colour component includes at least one of a first colour component, a second colour component, or a third colour component. Accordingly, the second determining unit 3204 is further configured to: after determining the processed point cloud corresponding to the reconstructed point cloud, if the colour component does not comply with an RGB colour space, perform colour space conversion on a colour component of a point in the processed point cloud to make the converted colour component comply with the RGB colour space.

It can be understood that, in embodiments, the “unit” may be part of a circuit, part of a processor, part of a program or software, etc., and of course may also be a module, or may be non-modular. In addition, various components described in embodiments of the disclosure may be integrated into one processing unit or may be present as a number of physically separated units, and two or more units may be integrated into one. The integrated unit may take the form of hardware or a software functional unit.

If the integrated units are implemented as software functional units and sold or used as standalone products, they may be stored in a computer-readable storage medium. Based on such an understanding, embodiments provide the computer storage medium applied in the decoder 320. The computer storage medium stores computer programs. The computer programs, when executed by the second processor, implement the method of any one of the foregoing embodiments.

Based on the components of the decoder 320 and the computer storage medium above, referring to FIG. 17, FIG. 17 is a schematic structural diagram illustrating hardware of the decoder 320 provided in embodiments of the disclosure. As illustrated in FIG. 17, the decoder 320: can include a second communication interface 3301, a second memory 3302, and a second processor 3303. These components are coupled together via a second bus system 3304. It should be understood that, the second bus system 3304 is configured for connection and communication between these components, and the second bus system 3304 further includes a power bus, a control bus, and a state signal bus in addition to a data bus. However, for the convenience of illustration, various buses are labeled as the second bus system 3304 in FIG. 17.

The second communication interface 3301 is configured to receive and send signals in the process of receiving and sending information with other external network elements. The second memory 3302 is configured to store computer programs executable by the second processor 3303. The second processor 3303 is configured to perform the following steps when running the computer programs: determining a reconstructed point set based on a reconstructed point cloud, where the reconstructed point set includes at least one point; inputting geometry information and a reconstructed value of an attribute to-be-processed of a point in the reconstructed point set into a preset network model, and determining a processed value of the attribute to-be-processed of the point in the reconstructed point set based on the preset network model; and determining a processed point cloud corresponding to the reconstructed point cloud according to the processed value of the attribute to-be-processed of the point in the reconstructed point set.

Optionally, as another embodiment, the second processor 3303 is further configured to perform the method according to any one of the foregoing embodiments when running the computer programs.

It can be understood that the second memory 3302 has a hardware function similar to that of the first memory 3102, and the second processor 3303 has a hardware function similar to that of the first processor 3103, which are not described in detail again herein.

Embodiments provide a decoder. With aid of the decoder, after obtaining the reconstructed point cloud, by performing quality enhancement on attribute information of the reconstructed point cloud based on the preset network model, it is possible to not only realize end-to-end operation, but also realize patching of the reconstructed point cloud by performing patch extraction and patch fusion on the point cloud, thereby effectively reducing resource consumption and improving robustness of the model. As such, by performing quality enhancement on the attribute information of the reconstructed point cloud based on the preset network model, it is possible to make the processed point cloud have clearer texture and more natural transition, which can effectively improve quality of the point cloud and visual effect, which means that the technical solutions lead to good performance, and quality of the point cloud and visual effect can be effectively improved.

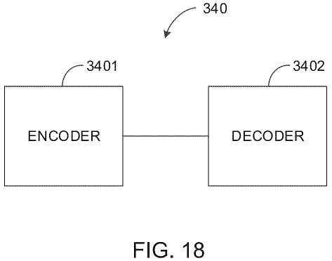

In another embodiment of the disclosure, referring to FIG. 18, FIG. 18 is a schematic structural diagram of a coding system provided in embodiments of the disclosure. As illustrated in FIG. 18, the coding system 340 can include an encoder 3401 and a decoder 3402, where the encoder 3401 can be the encoder described in any one of the foregoing embodiments, and the decoder 3402 can be the decoder described in any one of the foregoing embodiments.

In embodiments of the disclosure, with aid of the coding system 340, after obtaining a reconstructed point cloud, the encoder 3401 or the decoder 3402 can perform quality enhancement on attribute information of the reconstructed point cloud based on a preset network model, which is possible to not only realize an end-to-end operation, but also realize patching of the reconstructed point cloud, thereby effectively reducing resource consumption and improving robustness of the model. In addition, quality of the point cloud and visual effect can also be improved, thereby improving compression performance of the point cloud.

It is noted that in the disclosure, the terms “include”, “comprise”, or any other variations thereof are intended to cover non-exclusive inclusion, such that a process, method, article, or apparatus that includes a series of elements not only includes those elements but also includes other elements not explicitly listed or elements inherent in such process, method, article, or apparatus. Without further limitation, an element defined by the statement “comprises a . . . ” does not exclude the presence of additional identical elements in a process, method, article, or apparatus that includes the element.

The sequence numbers in embodiments of the disclosure are only for illustration and do not represent the advantages or disadvantages of embodiments.

The methods disclosed in several method embodiments provided in the disclosure may be combined in any manner without conflicts to obtain a new method embodiment.

The methods disclosed in several product embodiments provided in the disclosure may be combined in any manner without conflict to obtain a new product embodiment.

The features disclosed in the several method embodiments or apparatus embodiments provided in the disclosure may be combined in any manner without conflicts to obtain a new method embodiment or a new apparatus embodiment.

The following clauses describes aspects of the disclosure and constitutes part of the description.

1. A decoding method, comprising: determining a reconstructed point set based on a reconstructed point cloud, wherein the reconstructed point set comprises at least one point; inputting geometry information and a reconstructed value of an attribute to-be-processed of a point in the reconstructed point set into a preset network model, and determining a processed value of the attribute to-be-processed of the point in the reconstructed point set based on the preset network model; and determining a processed point cloud corresponding to the reconstructed point cloud according to the processed value of the attribute to-be-processed of the point in the reconstructed point set.

2. The method of clause 1, wherein determining the reconstructed point set based on the reconstructed point cloud comprises: determining a key point from the reconstructed point cloud; and performing extraction on the reconstructed point cloud according to the key point to determine the reconstructed point set, wherein the key point and the reconstructed point set have a correspondence.

3. The method of clause 2, wherein determining the key point from the reconstructed point cloud comprises: determining the key point by performing farthest point sampling (FPS) on the reconstructed point cloud.

4. The method of clause 2, wherein performing extraction on the reconstructed point cloud according to the key point to determine the reconstructed point set comprises: performing K nearest neighbor (KNN) search in the reconstructed point cloud according to the key point, to determine a neighbor point corresponding to the key point; and determining the reconstructed point set based on the neighbor point corresponding to the key point.

5. The method of clause 4, wherein performing KNN search in the reconstructed point cloud according to the key point to determine the neighbor point corresponding to the key point comprises: based on the key point, searching for a first preset number of candidate points in the reconstructed point cloud through KNN search; calculating a distance between the key point and each of the first preset number of candidate points, and determining a second preset number of smaller distances from the obtained first preset number of distances; and determining the neighbor point corresponding to the key point according to candidate points corresponding to the second preset number of distances, wherein the second preset number is smaller than or equal to the first preset number.

6. The method of clause 4, wherein determining the reconstructed point set based on the neighbor point corresponding to the key point comprises:

determining the reconstructed point set according to the key point and the neighbor point corresponding to the key point.

7. The method of clause 2, further comprising: determining the number of points in the reconstructed point cloud; and determining the number of key points according to the number of points in the reconstructed point cloud and the number of points in the reconstructed point set.

8. The method of clause 7, wherein determining the number of key points according to the number of points in the reconstructed point cloud and the number of points in the reconstructed point set comprises: determining a first factor; calculating a product of the number of points in the reconstructed point cloud and the first factor; and determining the number of key points according to the product and the number of points in the reconstructed point set.

9. The method of clause 2, wherein determining the processed point cloud corresponding to the reconstructed point cloud according to the processed value of the attribute to-be-processed of the point in the reconstructed point set comprises: determining a target set corresponding to the reconstructed point set according to the processed value of the attribute to-be-processed of the point in the reconstructed point set; and determining the processed point cloud according to the target set.

10. The method of clause 9, wherein determining the processed point cloud according to the target set comprises: when the key point is a plurality of key points, performing extraction on the reconstructed point cloud according to the plurality of key points to obtain a plurality of reconstructed point sets; and after determining target sets corresponding to the plurality of reconstructed point sets, determining the processed point cloud by performing fusion according to the plurality of target sets obtained.

11. The method of clause 10, wherein determining the processed point cloud by performing fusion according to the plurality of target sets obtained comprises: when at least two of the plurality of target sets comprise a processed value of an attribute to-be-processed of a first point, calculating the mean value of the obtained at least two processed values to determine a processed value of the attribute to-be-processed of the first point in the processed point cloud; when none of the plurality of target sets comprises the processed value of the attribute to-be-processed of the first point, determining a reconstructed value of the attribute to-be-processed of the first point in the reconstructed point cloud as the processed value of the attribute to-be-processed of the first point in the processed point cloud, wherein the first point is any one point in the reconstructed point cloud.

12. The method of clause 1, wherein inputting the geometry information and the reconstructed value of the attribute to-be-processed of the point in the reconstructed point set into the preset network model and determining the processed value of the attribute to-be-processed of the point in the reconstructed point set based on the preset network model comprises: in the preset network model, obtaining a graph structure of the point in the reconstructed point set by performing graph construction based on the reconstructed value of the attribute to-be-processed of the point in the reconstructed point set additionally with the geometry information of the point in the reconstructed point set, and determining the processed value of the attribute to-be-processed of the point in the reconstructed point set by performing graph convolution and graph attention mechanism on the graph structure of the point in the reconstructed point set.

13. The method of clause 1, wherein the preset network model is a deep learning-based neural network model, and the preset network model at least comprises a graph attention mechanism module and a graph convolutional module.

14. The method of clause 13, wherein the graph attention mechanism module comprises a first graph attention mechanism module and a second graph attention mechanism module, and the graph convolutional module comprises a first graph convolutional module, a second graph convolutional module, a third graph convolutional module, and a fourth graph convolutional module; and the preset network model further comprises a first pooling module, a second pooling module, a first concatenating module, a second concatenating module, a third concatenating module, and an addition module, wherein a first input end of the first graph attention mechanism module is used for receiving the geometry information, and a second input end of the first graph attention mechanism module is used for receiving the reconstructed value of the attribute to-be-processed; a first output end of the first graph attention mechanism module is connected to an input end of the first pooling module, an output end of the first pooling module is connected to an input end of the first graph convolutional module, and an output end of the first graph convolutional module is connected to a first input end of the first concatenating module; a second output end of the first graph attention mechanism module is connected to a first input end of the second concatenating module, a second input end of the second concatenating module is used for receiving the reconstructed value of the attribute to-be-processed, and an output end of the second concatenating module is connected to an input end of the second graph convolutional module; a first input end of the second graph attention mechanism module is used for receiving the geometry information, and a second input end of the second graph attention mechanism module is connected to an output end of the second graph convolutional module, a first output end of the second graph attention mechanism module is connected to an input end of the second pooling module, and an output end of the second pooling module is connected to a second input end of the first concatenating module; a second output end of the second graph attention mechanism module is connected to a first input end of the third concatenating module, a second input end of the third concatenating module is connected to an output end of the second graph convolutional module, an output end of the third concatenating module is connected to an input end of the third graph convolutional module, and an output end of the third graph convolutional module is connected to a third input end of the first concatenating module, and the output end of the second graph convolutional module is also connected to a fourth input end of the first concatenating module; and an output end of the first concatenating module is connected to an input end of the fourth graph convolutional module, an output end of the fourth graph convolutional module is connected to a first input end of the addition module, a second input end of the addition module is used for receiving the reconstructed value of the attribute to-be-processed, and an output end of the addition module is used for outputting the processed value of the attribute to-be-processed.

15. The method of clause 14, wherein inputting the geometry information and the reconstructed value of the attribute to-be-processed of the point in the reconstructed point set into the preset network model and determining the processed value of the attribute to-be-processed of the point in the reconstructed point set based on the preset network model comprises: performing, through the first graph attention mechanism module, feature extraction on the geometry information and the reconstructed value of the attribute to-be-processed, to obtain a first graph feature and a first attention feature; performing, through the first pooling module and the first graph convolutional module, feature extraction on the first graph feature to obtain a second graph feature; concatenating, through the second concatenating module, the first attention feature and the reconstructed value of the attribute to-be-processed to obtain a first concatenated attention feature; performing, through the second graph convolutional module, feature extraction on the first concatenated attention feature to obtain a second attention feature; performing, through the second graph attention mechanism module, feature extraction on the geometry information and the second attention feature to obtain a third graph feature and a third attention feature; performing, through the second pooling module, feature extraction on the third graph feature to obtain a fourth graph feature; concatenating, through the third concatenating module, the third attention feature and the second attention feature to obtain a second concatenated attention feature; performing, through the third graph convolutional module, feature extraction on the second concatenated attention feature to obtain a fourth attention feature; concatenating, through the first concatenating module, the second graph feature, the fourth graph feature, the second attention feature, and the fourth attention feature to obtain a target feature; performing, through the fourth graph convolutional module, convolution on the target feature to obtain a residual value of the attribute to-be-processed of the point in the reconstructed point set; and performing, through the addition module, addition on the residual value of the attribute to-be-processed of the point in the reconstructed point set and the reconstructed value of the attribute to-be-processed, to obtain the processed value of the attribute to-be-processed of the point in the reconstructed point set.

16. The method of clause 14, wherein each of the first graph convolutional module, the second graph convolutional module, the third graph convolutional module, and the fourth graph convolutional module comprises at least one convolutional layer.

17. The method of clause 16, wherein each of the first graph convolutional module, the second graph convolutional module, the third graph convolutional module, and the fourth graph convolutional module further comprises at least one batch normalization layer and at least one activation layer, wherein the batch normalization layer and the activation layer are connected following the convolutional layer.

18. The method of clause 17, wherein a last convolutional layer in the fourth graph convolutional module is not followed by the batch normalization layer and the activation layer.

19. The method of clause 15, wherein each of the first graph attention mechanism module and the second graph attention mechanism module comprises a fourth concatenating module and a preset number of graph attention mechanism sub-modules, and wherein in the first graph attention mechanism module, an input end of each of the preset number of graph attention mechanism sub-modules is used for receiving the geometry information and the reconstructed value of the attribute to-be-processed, an output end of each of the preset number of graph attention mechanism sub-modules is connected to an input end of the fourth concatenating module, and an output end of the fourth concatenating module is used for outputting the first graph feature and the first attention feature; and in the second graph attention mechanism module, an input end of each of the preset number of graph attention mechanism sub-modules is used for receiving the geometry information and the second attention feature, an output end of each of the preset number of graph attention mechanism sub-modules is connected to an input end of the fourth concatenating module, and an output end of the fourth concatenating module is used for outputting the third graph feature and the third attention feature.

20. The method of clause 19, wherein the graph attention mechanism sub-module is a single-head graph attention based point layer (GAPLayer) module.

21. The method of clause 19, wherein performing, through the first graph attention mechanism module, feature extraction on the geometry information and the reconstructed value of the attribute to-be-processed to obtain the first graph feature and the first attention feature comprises: inputting the geometry information and the reconstructed value of the attribute to-be-processed into the graph attention mechanism sub-module to obtain an initial graph feature and an initial attention feature; obtaining, through the preset number of graph attention mechanism sub-modules, a preset number of initial graph features and a preset number of initial attention features; concatenating, through the fourth concatenating module, the preset number of initial graph features to obtain the first graph feature; and concatenating, through the fourth concatenating module, the preset number of initial attention features to obtain the first attention feature.

22. The method of clause 21, wherein the graph attention mechanism sub-module at least comprises a plurality of multi-layer perceptron (MLP) modules, and inputting the geometry information and the reconstructed value of the attribute to-be-processed into the graph attention mechanism sub-module to obtain the initial graph feature and the initial attention feature comprises: obtaining a graph structure of the point in the reconstructed point set by performing graph construction based on the reconstructed value of the attribute to-be-processed additionally with the geometry information; performing, through at least one of the MLP modules, feature extraction on the graph structure to obtain the initial graph feature; performing, through at least one of the MLP modules, feature extraction on the reconstructed value of the attribute to-be-processed to obtain first intermediate feature information; performing, through at least one of the MLP modules, feature extraction on the initial graph feature to obtain second intermediate feature information; performing feature aggregation on the first intermediate feature information and the second intermediate feature information by using a first preset function, to obtain an attention coefficient; perform normalization on the attention coefficient by using a second preset function, to obtain a feature weight; and obtaining the initial attention feature according to the feature weight and the initial graph feature.

23. The method of clause 1, further comprising: determining a training sample set, wherein the training sample set comprises at least one point-cloud sequence; performing extraction on the at least one point-cloud sequence to obtain a plurality of sample point sets; and in a preset bit-rate, performing model training on an initial model by using geometry information and an original value of an attribute to-be-processed of the plurality of sample point sets, to determine the preset network model.

24. The method of any of clauses 1 to 23, wherein the attribute to-be-processed comprises a colour component, the colour component comprises at least one of a first colour component, a second colour component, or a third colour component, and the method further comprises: after determining the processed point cloud corresponding to the reconstructed point cloud, when the colour component does not comply with a red green blue (RGB) colour space, performing colour space conversion on a colour component of a point in the processed point cloud to make the converted colour component comply with the RGB colour space.

25. An encoding method, comprising: performing encoding and reconstruction according to an original point cloud to obtain a reconstructed point cloud; determining a reconstructed point set based on the reconstructed point cloud, wherein the reconstructed point set comprises at least one point; inputting geometry information and a reconstructed value of an attribute to-be-processed of a point in the reconstructed point set into a preset network model, and determining a processed value of the attribute to-be-processed of the point in the reconstructed point set based on the preset network model; and determining a processed point cloud corresponding to the reconstructed point cloud according to the processed value of the attribute to-be-processed of the point in the reconstructed point set.

26. The method of clause 25, wherein determining the reconstructed point set based on the reconstructed point cloud comprises: determining a key point from the reconstructed point cloud; and performing extraction on the reconstructed point cloud according to the key point to determine the reconstructed point set, wherein the key point and the reconstructed point set have a correspondence.

27 The method of clause 26, wherein determining the key point from the reconstructed point cloud comprises: determining the key point by performing farthest point sampling (FPS) on the reconstructed point cloud.

28. The method of clause 26, wherein performing extraction on the reconstructed point cloud according to the key point to determine the reconstructed point set comprises: performing K nearest neighbor (KNN) search in the reconstructed point cloud according to the key point, to determine a neighbor point corresponding to the key point; and determining the reconstructed point set based on the neighbor point corresponding to the key point.

29 The method of clause 28, wherein performing KNN search in the reconstructed point cloud according to the key point to determine the neighbor point corresponding to the key point comprises: based on the key point, searching for a first preset number of candidate points in the reconstructed point cloud through KNN search; calculating a distance between the key point and each of the first preset number of candidate points, and determining a second preset number of smaller distances from the obtained first preset number of distances; and determining the neighbor point corresponding to the key point according to candidate points corresponding to the second preset number of distances, wherein the second preset number is smaller than or equal to the first preset number.

30. The method of clause 28, wherein determining the reconstructed point set based on the neighbor point corresponding to the key point comprises: determining the reconstructed point set according to the key point and the neighbor point corresponding to the key point.

31. The method of clause 26, further comprising: determining the number of points in the reconstructed point cloud; and determining the number of key points according to the number of points in the reconstructed point cloud and the number of points in the reconstructed point set.

32. The method of clause 31, wherein determining the number of key points according to the number of points in the reconstructed point cloud and the number of points in the reconstructed point set comprises: determining a first factor; calculating a product of the number of points in the reconstructed point cloud and the first factor; and determining the number of key points according to the product and the number of points in the reconstructed point set.

33. The method of clause 26, wherein determining the processed point cloud corresponding to the reconstructed point cloud according to the processed value of the attribute to-be-processed of the point in the reconstructed point set comprises: determining a target set corresponding to the reconstructed point set according to the processed value of the attribute to-be-processed of the point in the reconstructed point set; and determining the processed point cloud according to the target set.

34. The method of clause 33, wherein determining the processed point cloud according to the target set comprises: when the key point is a plurality of key points, performing extraction on the reconstructed point cloud according to the plurality of key points to obtain a plurality of reconstructed point sets; and after determining target sets corresponding to the plurality of reconstructed point sets, determining the processed point cloud by performing fusion according to the plurality of target sets obtained.

35. The method of clause 34, wherein determining the processed point cloud by performing fusion according to the plurality of target sets obtained comprises: when at least two of the plurality of target sets comprise a processed value of an attribute to-be-processed of a first point, calculating the mean value of the obtained at least two processed values to determine a processed value of the attribute to-be-processed of the first point in the processed point cloud; when none of the plurality of target sets comprises the processed value of the attribute to-be-processed of the first point, determining a reconstructed value of the attribute to-be-processed of the first point in the reconstructed point cloud as the processed value of the attribute to-be-processed of the first point in the processed point cloud, wherein the first point is any one point in the reconstructed point cloud.

36. The method of clause 25, wherein inputting the geometry information and the reconstructed value of the attribute to-be-processed of the point in the reconstructed point set into the preset network model and determining the processed value of the attribute to-be-processed of the point in the reconstructed point set based on the preset network model comprises: in the preset network model, obtaining a graph structure of the point in the reconstructed point set by performing graph construction based on the reconstructed value of the attribute to-be-processed of the point in the reconstructed point set additionally with the geometry information of the point in the reconstructed point set, and determining the processed value of the attribute to-be-processed of the point in the reconstructed point set by performing graph convolution and graph attention mechanism on the graph structure of the point in the reconstructed point set.

37. The method of clause 25, wherein the preset network model is a deep learning-based neural network model, and the preset network model at least comprises a graph attention mechanism module and a graph convolutional module.

38. The method of clause 37, wherein the graph attention mechanism module comprises a first graph attention mechanism module and a second graph attention mechanism module, and the graph convolutional module comprises a first graph convolutional module, a second graph convolutional module, a third graph convolutional module, and a fourth graph convolutional module; and the preset network model further comprises a first pooling module, a second pooling module, a first concatenating module, a second concatenating module, a third concatenating module, and an addition module, wherein a first input end of the first graph attention mechanism module is used for receiving the geometry information, and a second input end of the first graph attention mechanism module is used for receiving the reconstructed value of the attribute to-be-processed; a first output end of the first graph attention mechanism module is connected to an input end of the first pooling module, an output end of the first pooling module is connected to an input end of the first graph convolutional module, and an output end of the first graph convolutional module is connected to a first input end of the first concatenating module; a second output end of the first graph attention mechanism module is connected to a first input end of the second concatenating module, a second input end of the second concatenating module is used for receiving the reconstructed value of the attribute to-be-processed, and an output end of the second concatenating module is connected to an input end of the second graph convolutional module; a first input end of the second graph attention mechanism module is used for receiving the geometry information, and a second input end of the second graph attention mechanism module is connected to an output end of the second graph convolutional module, a first output end of the second graph attention mechanism module is connected to an input end of the second pooling module, and an output end of the second pooling module is connected to a second input end of the first concatenating module; a second output end of the second graph attention mechanism module is connected to a first input end of the third concatenating module, a second input end of the third concatenating module is connected to an output end of the second graph convolutional module, an output end of the third concatenating module is connected to an input end of the third graph convolutional module, and an output end of the third graph convolutional module is connected to a third input end of the first concatenating module, and the output end of the second graph convolutional module is also connected to a fourth input end of the first concatenating module; and an output end of the first concatenating module is connected to an input end of the fourth graph convolutional module, an output end of the fourth graph convolutional module is connected to a first input end of the addition module, a second input end of the addition module is used for receiving the reconstructed value of the attribute to-be-processed, and an output end of the addition module is used for outputting the processed value of the attribute to-be-processed.

39. The method of clause 38, wherein inputting the geometry information and the reconstructed value of the attribute to-be-processed of the point in the reconstructed point set into the preset network model and determining the processed value of the attribute to-be-processed of the point in the reconstructed point set based on the preset network model comprises: performing, through the first graph attention mechanism module, feature extraction on the geometry information and the reconstructed value of the attribute to-be-processed, to obtain a first graph feature and a first attention feature; performing, through the first pooling module and the first graph convolutional module, feature extraction on the first graph feature to obtain a second graph feature; concatenating, through the second concatenating module, the first attention feature and the reconstructed value of the attribute to-be-processed to obtain a first concatenated attention feature; performing, through the second graph convolutional module, feature extraction on the first concatenated attention feature to obtain a second attention feature; performing, through the second graph attention mechanism module, feature extraction on the geometry information and the second attention feature to obtain a third graph feature and a third attention feature; performing, through the second pooling module, feature extraction on the third graph feature to obtain a fourth graph feature; concatenating, through the third concatenating module, the third attention feature and the second attention feature to obtain a second concatenated attention feature; performing, through the third graph convolutional module, feature extraction on the second concatenated attention feature to obtain a fourth attention feature; concatenating, through the first concatenating module, the second graph feature, the fourth graph feature, the second attention feature, and the fourth attention feature to obtain a target feature; performing, through the fourth graph convolutional module, convolution on the target feature to obtain a residual value of the attribute to-be-processed of the point in the reconstructed point set; and performing, through the addition module, addition on the residual value of the attribute to-be-processed of the point in the reconstructed point set and the reconstructed value of the attribute to-be-processed, to obtain the processed value of the attribute to-be-processed of the point in the reconstructed point set.

40. The method of clause 38, wherein each of the first graph convolutional module, the second graph convolutional module, the third graph convolutional module, and the fourth graph convolutional module comprises at least one convolutional layer.

41. The method of clause 40, wherein each of the first graph convolutional module, the second graph convolutional module, the third graph convolutional module, and the fourth graph convolutional module further comprises at least one batch normalization layer and at least one activation layer, wherein the batch normalization layer and the activation layer are connected following the convolutional layer.

42. The method of clause 41, wherein a last convolutional layer in the fourth graph convolutional module is not followed by the batch normalization layer and the activation layer.

43 The method of clause 39, wherein each of the first graph attention mechanism module and the second graph attention mechanism module comprises a fourth concatenating module and a preset number of graph attention mechanism sub-modules, and wherein in the first graph attention mechanism module, an input end of each of the preset number of graph attention mechanism sub-modules is used for receiving the geometry information and the reconstructed value of the attribute to-be-processed, an output end of each of the preset number of graph attention mechanism sub-modules is connected to an input end of the fourth concatenating module, and an output end of the fourth concatenating module is used for outputting the first graph feature and the first attention feature; and in the second graph attention mechanism module, an input end of each of the preset number of graph attention mechanism sub-modules is used for receiving the geometry information and the second attention feature, an output end of each of the preset number of graph attention mechanism sub-modules is connected to an input end of the fourth concatenating module, and an output end of the fourth concatenating module is used for outputting the third graph feature and the third attention feature.

44. The method of clause 43, wherein the graph attention mechanism sub-module is a single-head graph attention based point layer (GAPLayer) module.

45. The method of clause 43, wherein performing, through the first graph attention mechanism module, feature extraction on the geometry information and the reconstructed value of the attribute to-be-processed to obtain the first graph feature and the first attention feature comprises: inputting the geometry information and the reconstructed value of the attribute to-be-processed into the graph attention mechanism sub-module to obtain an initial graph feature and an initial attention feature; obtaining, through the preset number of graph attention mechanism sub-modules, a preset number of initial graph features and a preset number of initial attention features; concatenating, through the fourth concatenating module, the preset number of initial graph features to obtain the first graph feature; and concatenating, through the fourth concatenating module, the preset number of initial attention features to obtain the first attention feature.

46. The method of clause 45, wherein the graph attention mechanism sub-module at least comprises a plurality of multi-layer perceptron (MLP) modules, and inputting the geometry information and the reconstructed value of the attribute to-be-processed into the graph attention mechanism sub-module to obtain the initial graph feature and the initial attention feature comprises: obtaining a graph structure of the point in the reconstructed point set by performing graph construction based on the reconstructed value of the attribute to-be-processed additionally with the geometry information; performing, through at least one of the MLP modules, feature extraction on the graph structure to obtain the initial graph feature; performing, through at least one of the MLP modules, feature extraction on the reconstructed value of the attribute to-be-processed to obtain first intermediate feature information; performing, through at least one of the MLP modules, feature extraction on the initial graph feature to obtain second intermediate feature information; performing feature aggregation on the first intermediate feature information and the second intermediate feature information by using a first preset function, to obtain an attention coefficient; perform normalization on the attention coefficient by using a second preset function, to obtain a feature weight; and obtaining the initial attention feature according to the feature weight and the initial graph feature.

47. The method of clause 25, further comprising: determining a training sample set, wherein the training sample set comprises at least one point-cloud sequence; performing extraction on the at least one point-cloud sequence to obtain a plurality of sample point sets; and in a preset bit-rate, performing model training on an initial model by using geometry information and an original value of an attribute to-be-processed of the plurality of sample point sets, to determine the preset network model.

48. The method of any of clauses 25 to 47, wherein the attribute to-be-processed comprises a colour component, the colour component comprises at least one of a first colour component, a second colour component, or a third colour component, and the method further comprises: after determining the processed point cloud corresponding to the reconstructed point cloud, when the colour component does not comply with a red green blue (RGB) colour space, performing colour space conversion on a colour component of a point in the processed point cloud to make the converted colour component comply with the RGB colour space.

49. An encoder, comprising: an encoding unit configured to perform encoding and reconstruction according to an original point cloud to obtain a reconstructed point cloud; a first extraction unit configured to determine a reconstructed point set based on the reconstructed point cloud, wherein the reconstructed point set comprises at least one point; a first model unit configured to input geometry information and a reconstructed value of an attribute to-be-processed of a point in the reconstructed point set into a preset network model, and determine a processed value of the attribute to-be-processed of the point in the reconstructed point set based on the preset network model; and a first fusion unit configured to determine a processed point cloud corresponding to the reconstructed point cloud according to the processed value of the attribute to-be-processed of the point in the reconstructed point set.

50. An encoder, comprising a first memory and a first processor, wherein the first memory is configured to store computer programs executable by the first processor; and the first processor is configured to perform the method of any of clauses 25 to 48 when executing the computer programs.

51. A decoder, comprising: a second extraction unit configured to determine a reconstructed point set based on a reconstructed point cloud, wherein the reconstructed point set comprises at least one point; a second model unit configured to input geometry information and a reconstructed value of an attribute to-be-processed of a point in the reconstructed point set into a preset network model, and determine a processed value of the attribute to-be-processed of the point in the reconstructed point set based on the preset network model; and a second fusion unit configured to determine a processed point cloud corresponding to the reconstructed point cloud according to the processed value of the attribute to-be-processed of the point in the reconstructed point set.

52. A decoder, comprising a second memory and a second processor, wherein the second memory is configured to store computer programs executable by the second processor; and the second processor is configured to perform the method of any of clauses 1 to 24 when executing the computer programs.

53. A computer-readable storage medium, configured to store computer programs which, when executed, are operable to perform the method of any of clauses 1 to 24 or the method of any of clauses 25 to 48.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

### INDUSTRIAL APPLICABILITY

In embodiments of the disclosure, at an encoding end or a decoding end, a reconstructed point set is determined based on a reconstructed point cloud. Geometry information and a reconstructed value of an attribute to-be-processed of a point in the reconstructed point set are input into a preset network model, and a processed value of the attribute to-be-processed of the point in the reconstructed point set is determined based on the preset network model. A processed point cloud corresponding to the reconstructed point cloud is determined according to the processed value of the attribute to-be-processed of the point in the reconstructed point set. In this way, by performing quality enhancement on attribute information of the reconstructed point cloud based on the preset network model, not only end-to-end operation is achieved, but also patching of the reconstructed point cloud is realized by determining the reconstructed point set from the reconstructed point cloud, thereby effectively reducing resource consumption and improving robustness of the model. In addition, when performing quality enhancement on the attribute information of the reconstructed point cloud based on the preset network model by using the geometry information as an auxiliary input of the preset network model, it is possible to make the processed point cloud have clearer texture and more natural transition, which can effectively improve quality of the point cloud and visual effect, thereby improving compression performance of the point cloud.

I/We claim:

1. A decoding method, comprising:
determining a reconstructed point set based on a reconstructed point cloud, wherein the reconstructed point set comprises at least one point;
inputting geometry information and a reconstructed value of an attribute to-be-processed of a point in the reconstructed point set into a preset network model, and determining a processed value of the attribute to-be-processed of the point in the reconstructed point set based on the preset network model; and
determining a processed point cloud corresponding to the reconstructed point cloud according to the processed value of the attribute to-be-processed of the point in the reconstructed point set.

2. The method of claim 1, wherein determining the reconstructed point set based on the reconstructed point cloud comprises:
determining a key point from the reconstructed point cloud; and
performing extraction on the reconstructed point cloud according to the key point to determine the reconstructed point set, wherein the key point and the reconstructed point set have a correspondence.

3. The method of claim 2, wherein determining the key point from the reconstructed point cloud comprises:
determining the key point by performing farthest point sampling (FPS) on the reconstructed point cloud.

4. The method of claim 2, wherein performing extraction on the reconstructed point cloud according to the key point to determine the reconstructed point set comprises:
performing K nearest neighbor (KNN) search in the reconstructed point cloud according to the key point, to determine a neighbor point corresponding to the key point; and
determining the reconstructed point set based on the neighbor point corresponding to the key point.

5. The method of claim 4, wherein performing KNN search in the reconstructed point cloud according to the key point to determine the neighbor point corresponding to the key point comprises:
based on the key point, searching for a first preset number of candidate points in the reconstructed point cloud through KNN search;
calculating a distance between the key point and each of the first preset number of candidate points, and determining a second preset number of smaller distances from the obtained first preset number of distances; and
determining the neighbor point corresponding to the key point according to candidate points corresponding to the second preset number of distances, wherein the second preset number is smaller than or equal to the first preset number.

6. The method of claim 4, wherein determining the reconstructed point set based on the neighbor point corresponding to the key point comprises:
determining the reconstructed point set according to the key point and the neighbor point corresponding to the key point.

7. The method of claim 2, further comprising:
determining the number of points in the reconstructed point cloud; and
determining the number of key points according to the number of points in the reconstructed point cloud and the number of points in the reconstructed point set.

8. The method of claim 7, wherein determining the number of key points according to the number of points in the reconstructed point cloud and the number of points in the reconstructed point set comprises:
determining a first factor;
calculating a product of the number of points in the reconstructed point cloud and the first factor; and
determining the number of key points according to the product and the number of points in the reconstructed point set.

9. The method of claim 2, wherein determining the processed point cloud corresponding to the reconstructed point cloud according to the processed value of the attribute to-be-processed of the point in the reconstructed point set comprises:
determining a target set corresponding to the reconstructed point set according to the processed value of the attribute to-be-processed of the point in the reconstructed point set;
when the key point is a plurality of key points, performing extraction on the reconstructed point cloud according to the plurality of key points to obtain a plurality of reconstructed point sets; and
after determining target sets corresponding to the plurality of reconstructed point sets, determining the processed point cloud by performing fusion according to the plurality of target sets obtained.

10. The method of claim 9, wherein determining the processed point cloud by performing fusion according to the plurality of target sets obtained comprises:
when at least two of the plurality of target sets comprise a processed value of an attribute to-be-processed of a first point, calculating the mean value of the obtained at least two processed values to determine a processed value of the attribute to-be-processed of the first point in the processed point cloud;
when none of the plurality of target sets comprises the processed value of the attribute to-be-processed of the first point, determining a reconstructed value of the attribute to-be-processed of the first point in the reconstructed point cloud as the processed value of the attribute to-be-processed of the first point in the processed point cloud;
wherein the first point is any one point in the reconstructed point cloud.

11. The method of claim 1, wherein inputting the geometry information and the reconstructed value of the attribute to-be-processed of the point in the reconstructed point set into the preset network model and determining the processed value of the attribute to-be-processed of the point in the reconstructed point set based on the preset network model comprises:
in the preset network model, obtaining a graph structure of the point in the reconstructed point set by performing graph construction based on the reconstructed value of the attribute to-be-processed of the point in the reconstructed point set additionally with the geometry information of the point in the reconstructed point set, and determining the processed value of the attribute to-be-processed of the point in the reconstructed point set by performing graph convolution and graph attention mechanism on the graph structure of the point in the reconstructed point set.

12. An encoding method, comprising:
performing encoding and reconstruction according to an original point cloud to obtain a reconstructed point cloud;
determining a reconstructed point set based on the reconstructed point cloud, wherein the reconstructed point set comprises at least one point;
inputting geometry information and a reconstructed value of an attribute to-be-processed of a point in the reconstructed point set into a preset network model, and determining a processed value of the attribute to-be-processed of the point in the reconstructed point set based on the preset network model; and
determining a processed point cloud corresponding to the reconstructed point cloud according to the processed value of the attribute to-be-processed of the point in the reconstructed point set.

13. The method of claim 12, wherein determining the reconstructed point set based on the reconstructed point cloud comprises:
determining a key point from the reconstructed point cloud; and
performing extraction on the reconstructed point cloud according to the key point to determine the reconstructed point set, wherein the key point and the reconstructed point set have a correspondence.

14. The method of claim 13, wherein determining the key point from the reconstructed point cloud comprises:
determining the key point by performing farthest point sampling (FPS) on the reconstructed point cloud.

15. The method of claim 13, wherein performing extraction on the reconstructed point cloud according to the key point to determine the reconstructed point set comprises:
performing K nearest neighbor (KNN) search in the reconstructed point cloud according to the key point, to determine a neighbor point corresponding to the key point; and
determining the reconstructed point set based on the neighbor point corresponding to the key point.

16. The method of claim 15, wherein performing KNN search in the reconstructed point cloud according to the key point to determine the neighbor point corresponding to the key point comprises:
based on the key point, searching for a first preset number of candidate points in the reconstructed point cloud through KNN search;
calculating a distance between the key point and each of the first preset number of candidate points, and determining a second preset number of smaller distances from the obtained first preset number of distances; and
determining the neighbor point corresponding to the key point according to candidate points corresponding to the second preset number of distances, wherein the second preset number is smaller than or equal to the first preset number.

17. The method of claim 15, wherein determining the reconstructed point set based on the neighbor point corresponding to the key point comprises:
determining the reconstructed point set according to the key point and the neighbor point corresponding to the key point.

18. The method of claim 13, further comprising:
determining the number of points in the reconstructed point cloud; and
determining the number of key points according to the number of points in the reconstructed point cloud and the number of points in the reconstructed point set.

19. The method of claim 13, wherein determining the processed point cloud corresponding to the reconstructed point cloud according to the processed value of the attribute to-be-processed of the point in the reconstructed point set comprises:
determining a target set corresponding to the reconstructed point set according to the processed value of the attribute to-be-processed of the point in the reconstructed point set;
when the key point is a plurality of key points, performing extraction on the reconstructed point cloud according to the plurality of key points to obtain a plurality of reconstructed point sets; and
after determining target sets corresponding to the plurality of reconstructed point sets, determining the processed point cloud by performing fusion according to the plurality of target sets obtained.

20. A non-transitory computer-readable storage medium storing a bitstream generated according to an encoding method, wherein the encoding method comprises:
performing encoding and reconstruction according to an original point cloud to obtain a reconstructed point cloud;
determining a reconstructed point set based on the reconstructed point cloud, wherein the reconstructed point set comprises at least one point;
inputting geometry information and a reconstructed value of an attribute to-be-processed of a point in the reconstructed point set into a preset network model, and determining a processed value of the attribute to-be-processed of the point in the reconstructed point set based on the preset network model; and
determining a processed point cloud corresponding to the reconstructed point cloud according to the processed value of the attribute to-be-processed of the point in the reconstructed point set.
